(19) United States
(12) Patent Application Publication
(10) Pub. No.: US 2014/0006296 A1
(43) Pub. Date: Jan. 2, 2014

(54) Systems and Methods for Information Compliance Risk Assessment

(71) Applicant: The Procter & Gamble Company, Cincinnati, OH (US)

(72) Inventors: Sandra Renee Hughes, Cincinnati, OH (US); Jeffrey M. Rozek, North Royalton, OH (US)

(21) Appl. No.: 13/932,053

(22) Filed: Jul. 1, 2013

Related U.S. Application Data
(60) Provisional application No. 61/666,987, filed on Jul. 2, 2012.

(51) Int. Cl. G06Q 30/00

(52) U.S. Cl. CPC G06Q 30/018
USPC 705/317

(57) ABSTRACT

Included are embodiments for information compliance risk assessment. Some embodiments include providing a plurality of questions to a user to determine a characteristic of a project that a user wishes to perform, determining, from the characteristic, a compliance area that is associated with the project, and determining a compliance officer associated with the compliance area to assist in completing the project. Some embodiments include determining a policy within the compliance area for completing the project, receiving an indication of compliance with the policy from the user, and providing the compliance officer with access to the indication of compliance and an option to indicate that the compliance area has been completed with adherence to the policy. Still some embodiments include receiving conformation from the compliance officer that the compliance area has been completed with adherence to the policy and providing the indication to the user for display.

### FIELD OF THE INVENTION

The present application relates generally to providing compliance risk assessment, including risk associated with handling information. The present invention specifically provides a platform for project managers to achieve compliance over a plurality of compliance areas.

### BACKGROUND OF THE INVENTION

In many corporate environments, projects may commence without adequate knowledge of the statutes, regulations, corporate polices, etc. that may define, affect, impact and/or control the scope of a project. As an example, if a corporate division, such as research and development, decides to produce, market, and sell a new widget, the division leaders may not realize that an intellectual property assessment may need to be made; that a safety assessment may need to be made; that an importation/exportation regulation assessment may need to be made; etc. As such, oftentimes, this corporate division will encounter unknown costs, delays, and/or obstacles to completing the project.

### SUMMARY OF THE INVENTION

Included are embodiments for compliance risk assessment over a plurality of compliance areas. One embodiment is directed to handling information and is a risk assessment tool to be utilized when information is handled (the term “handled” as it related to information and as used herein includes but is not limited to information storing, archiving, searching, retrieving, sharing, parsing, analyzing, evaluating, transporting and/or transferring). Some embodiments include providing a plurality of questions to a user to determine a characteristic of a project that a user wishes to perform, determining, from the characteristic, a compliance area that is associated with the project, and determining a compliance officer associated with the compliance area to assist in completing the project. Some embodiments include determining a policy within the compliance area for completing the project, receiving an indication of compliance with the policy from the user, and providing the compliance officer with access to the indication of compliance and an option to indicate that the compliance area has been completed with adherence to the policy. Still some embodiments include receiving conformation from the compliance officer that the compliance area has been completed with adherence to the policy and providing the indication to the user for display.

Also included are embodiments of a non-transitory computer-readable medium. Some embodiments of the non-transitory computer-readable medium are configured to provide a plurality of questions to a project manager to determine a characteristic of a project that a project manager wishes to perform, determine, from the characteristic, a compliance area that is associated with the project, and determine a compliance officer associated with the compliance area to assist in completing the project. Some embodiments are configured to receive, from the compliance officer, a policy within the compliance area for completing the project, facilitate an electronic communication between the project manager and the compliance officer, and receive an indication from the compliance officer that the compliance area has been completed with adherence to the policy.

Also included are embodiments of a method. Some embodiments of the method include providing a plurality of questions to a project manager to determine a characteristic of a project that a project manager wishes to perform, determining, from the characteristic, a compliance area that is associated with the project, and determining a compliance officer associated with the compliance area to assist in completing the project. Some embodiments include informing the compliance officer of the project, receiving, from the compliance officer, a policy within the compliance area for completing the project, and providing, by a computing device, a project manager interface and a compliance officer interface to facilitate an electronic communication between the project manager and the compliance officer. Still some embodiments include receiving an indication from the compliance officer that the compliance area has been completed with adherence to the policy and providing the indication to the project manager for display.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for providing information compliance risk assessment, according to embodiments disclosed herein;

FIG. 2 depicts a remote computing device for providing information compliance risk assessment, according to embodiments disclosed herein;

FIG. 3 depicts a project manager interface for providing options for managing a project, according to embodiments disclosed herein;

FIGS. 4A, 4B depict a project manager interface for creating a project assessment, according to embodiments disclosed herein;

FIGS. 5A-5F depict a project manager interface for providing a questionnaire for the project, according to embodiments disclosed herein;

FIG. 6 depicts a project manager interface for providing a project scorecard, according to embodiments disclosed herein;

FIG. 7 depicts a project manager interface for providing compliance guidance, according to embodiments disclosed herein;

FIG. 8 depicts a project manager interface for providing initiative activity plans, according to embodiments disclosed herein;

FIG. 9 depicts a project manager interface for providing an activity plan detail, according to embodiments disclosed herein;

FIG. 10 depicts another project manager interface for providing an activity plan detail, according to embodiments disclosed herein;

FIGS. 11A-11C depict a compliance officer interface for providing a central cockpit of project data, according to embodiments disclosed herein;

FIG. 12 depicts an administrator interface for managing components of project compliance, according to embodiments disclosed herein;

FIG. 13 depicts an administrator interface for managing compliance scoring of the questionnaire, according to embodiments disclosed herein;

FIG. 14 depicts an administrator interface for creating, removing, and/or editing a rule, according to embodiments disclosed herein;

FIG. 15 depicts an administrator interface for editing questions of the questionnaire, according to embodiments disclosed herein;

FIG. 16 depicts an administrator interface for editing a group of questions in the questionnaire, according to embodiments disclosed herein;

FIG. 17 depicts an administrator interface for editing an individual question in the questionnaire, according to embodiments disclosed herein; and

FIG. 18 depicts a flowchart for providing information compliance risk assessment, according to embodiments disclosed herein.

### DETAILED DESCRIPTION OF THE INVENTION

Embodiments disclosed herein include systems and methods for compliance risk assessment, including, in particular, compliance risk assessment when a particular project or initiative involves handling information and/or data. Accordingly, embodiments may be configured to provide a plurality of intranet (or internal interfaces for monitoring and achieving compliance for a particular project or initiative. At an initial phase of the project, a project manager may access a first interface, which may provide a plurality of predetermined questions related to the project. The questions may solicit answers related to the type of project involved, outside parties, financing, target beneficiaries, whether the project involves a regulated area, classification of data involved, business impact studies, electronic infrastructure utilized, geographies involved, intellectual property involved, etc. Once the project manager has satisfactorily answered the questions, embodiments may then determine which compliance areas, statutes, regulations, and/or corporate policies might be involved. A determination may additionally be made regarding the one or more compliance officers and/or other resources that may be accessed to ensure compliance.

The selected compliance officer may then be contacted with information regarding the project and provide the selected compliance officer with access to the system. Depending on the particular configuration, different compliance officers may be assigned to various portions of the project. The project manager may receive the compliance requirements and may contact the compliance officer to discuss the various portions of the project. The project manager may additionally access other resources within the system to assist with compliance. The project manager may submit, to the system, documentation and/or other information that is made accessible to the compliance officer. The compliance officer may approve that portion of the project for compliance and/or identify the areas of noncompliance and assist in gaining compliance.

In some embodiments, if compliance with a first portion of the project overlaps with compliance of a second portion of the project, the compliance officer for the first portion may communicate with the compliance officer of the second portion to further streamline the process. Thus, referring to the example above, if the project manager indicates in the initial questionnaire that financing for the project is to be received from a third party, compliance officer for financing and compliance officer for outside parties may be included in the project. Accordingly, these compliance officers may communicate with each other to ensure that compliance is gained efficiently.

Thus, embodiments described herein allow compliance officers to view communication between other compliance officers and/or between a compliance officer and the project manager in real time. This leads to considerable efficiency for the compliance organizations as they can coordinate and communicate. Many times there is overlap in the compliance areas and this allows a compliance area to “stand down” and allow another area to handle an issue without significant effort by the project manager and the compliance functions.

Additionally, as compliance is achieved for the various portions of the project, an interface may be provided to the project manager that indicates the portions where compliance is achieved, the portions where compliance has yet to be achieved, and/or the portions where compliance is not required. Selecting one or more of these topics may provide the project manager with additional information regarding the compliance status. Once total compliance has been achieved, the project manager may continue with the subsequent action items for completing the project.

It should be understood that in some embodiments, a project manager can run a plurality of different scenarios for their project by changing the inputs and seeing how those changes affect risk, and therefore complexity and timelines. This feature allows modification of a project scope early in project establishment and allows informed discussion by project manager and the business supporting the project as to what factors can be changed or modified to affect level of risk. Likewise, if a project includes some “must-haves” that create high risks, this feature allows appropriate allocation of budget, timelines, and human resources at an earlier stage in the project and may inform execution strategy of an entire portfolio of projects.

Additionally, embodiments disclosed herein can be used to determine upcoming tasks, so that the project manager and compliance officers may plan ahead. Specifically, the upcoming tasks can be searched to determine which areas of risk and/or which compliance area and/or which organization the project is facing in the foreseeable future. This allows mapping and timing of issues and may suggest additional resources or energy to allocate or find expertise in a particular area of risk.

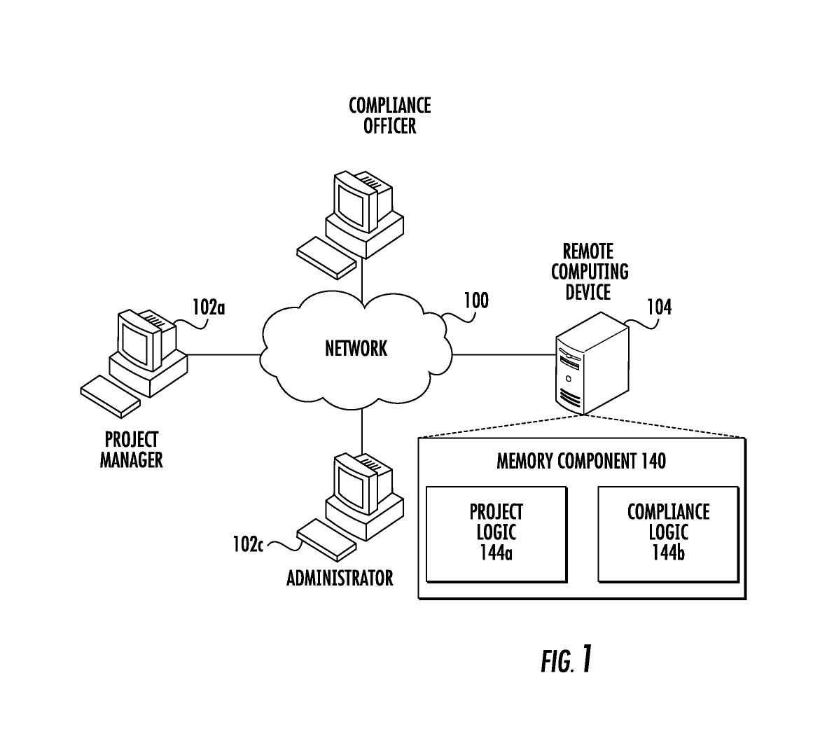

Referring now to the drawings, FIG. 1 depicts a system for providing information compliance risk assessment, according to embodiments disclosed herein. As illustrated, a network 100 may be part of a closed corporate network or other intranet configuration that communicates with a plurality of authorized computing devices. In some embodiments, the network 100 may include a wide area network, such as the internet, a mobile communications network, a satellite network, a public service telephone network (PSTN) and/or other network for facilitating communication between numerous devices, regardless of affiliation or authorization.

Coupled to the network 100 are a project manager device 102a, a compliance officer device 102b, an administrator device 102c, and a remote computing device 104. The project manager device 102a may be utilized for a project manager to create, monitor, and achieve compliance for a project. Specifically, the project manager may create a new project to which compliance may be required. The project manager may be unaware of the types of compliance required for the project, so the project manager may access one or more project manager interfaces, as depicted below to create, manage, and achieve the desired compliance.

Also coupled to the network 100 is the compliance officer device 102b. Upon creation of the project, a compliance officer may access the compliance officer device 102b to determine whether the project has met compliance requirements. Specifically, the project manager may answer a plurality of questions related to the project and then be provided with a listing of compliance officers from whom compliance must be obtained. If the compliance officer on the compliance officer device 102b has been identified as an interested party, the compliance officer may access one or more of the project manager interfaces to review the specifics of the project and determine whether compliance has been met for that facet of the project. If so, the compliance officer may identify that compliance for that compliance area has been met.

The administrator device 102c is also coupled to the network 100 and may be configured to facilitate adding, removing, and/or editing of questions and other features of the information compliance risk assessment platform. As described in more detail below, one or more administrator interfaces may be provided for altering the platform to more accurately and efficiently manage compliance of projects.

The remote computing device 104 is also coupled to the network 100 and may be configured for providing the platform to the project manager device 102a, the compliance officer device 102b, and the administrator device 102c. Specifically, the remote computing device 104 may provide one or more interfaces for providing information to the users of the platform, as well as to identify areas where compliance may be required and/or achieved. Accordingly, the remote computing device 104 may include a memory component 140, which stores project logic 144a and compliance logic 144b for performing these actions. When executed by the remote computing device 104, the project logic 144a may cause the remote computing device 104 to interact with users by providing the interfaces and storing results. Similarly, the compliance logic 144b may cause the remote computing device 104 to utilize the received information to determine which aspects of compliance are required and/or whether that compliance has been achieved. Other functionality may also be provided by these logic components.

It should be understood that while the project manager device 102a, the compliance officer device 102b, and the administrator device 102c are depicted as personal computers and the remote computing device 104 is depicted as a server, these are merely examples. Specifically, the project manager device 102a, the compliance officer device 102b, the administrator device 102c, and the remote computing device 104 may be any type of computing device (e.g. mobile computing device, tablets, personal computer, mobile phone, personal digital assistant, etc.). Additionally, while these devices 102-104 are each depicted in FIG. 1 as a single piece of hardware, this is also an example. Each of the devices 104-106 may represent a plurality of servers, personal computers, laptop computers, mobile phones, tablets, etc.

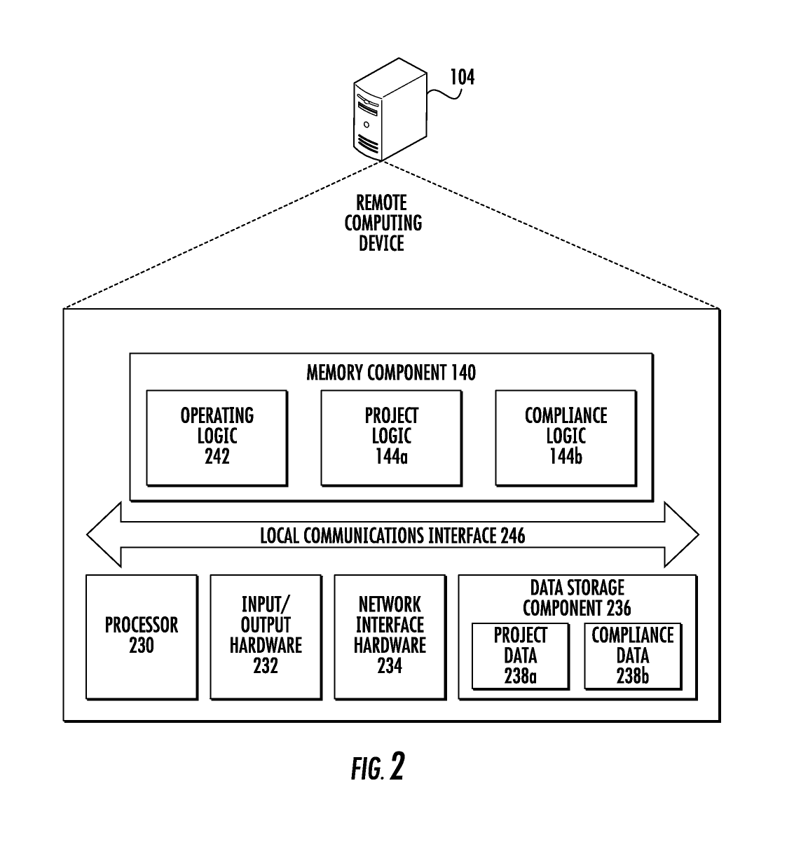

FIG. 2 depicts a remote computing device 104 for providing information compliance risk assessment, according to embodiments disclosed herein. In the illustrated embodiment, the remote computing device 104 includes a processor 230, input/output hardware 232, network interface hardware 234, a data storage component 236 (which stores project data 238a and compliance data 238b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, these non-transitory computer-readable mediums may reside within the remote computing device 104 and/or external to the remote computing device 104.

Additionally, the memory component 140 may be configured to store operating logic 242, the project logic 144a, and the compliance logic 144b, each of which may be embodied as a computer program, firmware, and/or hardware, as an example. A local communications interface 246 is also included in FIG. 2 and may be implemented as a bus or other interface to facilitate communication among the components of the remote computing device 104.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the remote computing device 104 and other computing devices.

Similarly, it should be understood that the data storage component 236 may reside local to and/or remote from the remote computing device 104 and may be configured to store one or more pieces of data for access by the remote computing device 104 and/or other components. In some embodiments, the data storage component 236 may be located remotely from the remote computing device 104 and thus accessible via the network 100. In some embodiments however, the data storage component 236 may merely be a peripheral device, but external to the remote computing device 104.

Included in the memory component 140 are the operating logic 242, the project logic 144a and the compliance logic 144b. The operating logic 242 may include an operating system and/or other software for managing components of the remote computing device 104. As discussed above, the project logic 144a may be configured to cause the remote computing device 104 to provide one or more interfaces and facilitate the communication and storage of other data related to a project. The compliance logic 144b may be configured to determine which compliance officer should be included in the project compliance determination and/or determine whether that compliance has been met. To this end, the project data 238a may include interfaces and other data related to the platform, projects, and compliances. The compliance data 238b may include data related to the criteria for gaining compliance, data from each identified compliance officer (or compliance subject matter expert), and/or data related to whether compliance has been achieved. Other data may also be stored in the data storage component 236.

It should be understood that the components illustrated in FIG. 2 are merely exemplary and are not intended to limit the scope of this disclosure. While the components in FIG. 2 are illustrated as residing within the remote computing device 104, this is merely an example. In some embodiments, one or more of the components may reside external to the remote computing device 104. It should also be understood that, while the remote computing device 104 in FIGS. 1 and 2 is illustrated as a single system, this is also merely an example. In some embodiments, the content providing functionality is implemented separately from the advertisement functionality, which may be implemented with separate hardware, software, and/or firmware.

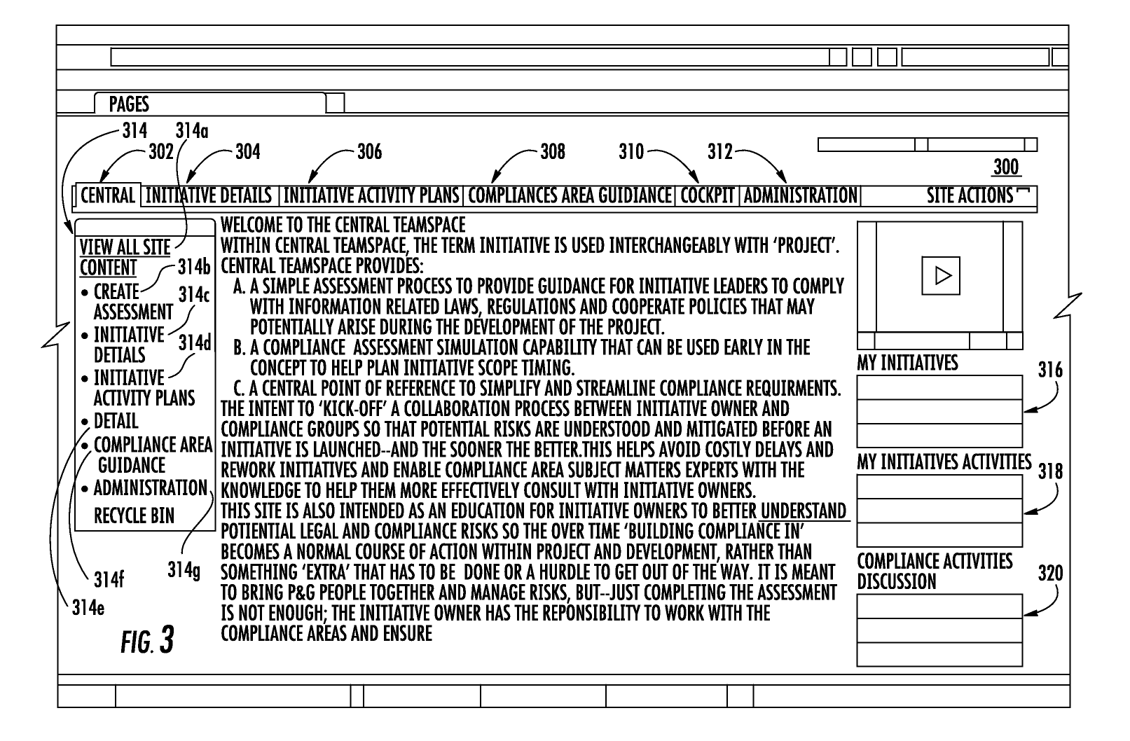

FIG. 3 depicts a project manager interface 300 for providing options for managing a project, according to embodiments disclosed herein. As illustrated, the project manager interface 300 may be provided for a project manager to create, edit, and/or manage a project. As an example, if the project manager wishes to create a new widget that will be manufactured in China, for distribution from the United States to other countries, there may be numerous compliance issues. As an example, there may be product safety compliance issues for the United States, importation issues for the United States, intellectual property issues for the United States, export issues for China, importation issues for the other countries, etc. Accordingly, to manage the project and the various compliance areas, the user may access the project manager interface 300.

The project manager interface 300 may include a platform central tab 302, an initiative details tab 304, an initiative activity plans tab 306, a compliance area guidance tab 308, a cockpit tab 310, and an administration tab 312. As described in more detail below, the initiative details tab 304 may provide the project manager with options for providing specifics of the project that is being created. The initiative activity plans tab 306 may be selected to provide information on the upcoming tasks that will be performed for the project in obtaining compliance across a plurality of policy areas. The compliance area guidance tab 308 may be selected for providing the project manager with guidance in achieving compliance for each compliance policy. This guidance may be provided by a compliance officer and/or determined by the remote computing device 104, based on known features of the project. The cockpit tab 310 may be selected to provide the current compliance status of the project from a variety of views (e.g., all projects within an organization, a geography, by project methodology, etc.). The administration tab 312 may be provided for allowing an administrator to add, edit, and/or change one or more features of the platform.

Similarly, upon selection of the platform central tab 302, the project manager interface 300 may be provided. The project manager interface 300 includes a site content section 314, which includes a view all content option 314a, a create assessment option 314b, an initiative details option 314c, an initiative activity plans option 314d, a cockpit option 314e, and a compliance area guidance option 314f. As is evident, at least a portion of the options 314a, 314c-314e are also depicted as tabs 302-312. Thus, the project manager may have dual options for accessing various portions of the platform. With that said, the create assessment option 314b may be utilized to begin a new project for which compliance needs to be gained.

Also included is an initiatives section 316, an initiative activities section 318, and a compliance activities discussion section 320. The initiatives section 316 may provide the project manager with the initiatives/projects that are currently pending. The initiative activities section 318 may provide the project manager with information related to recent and upcoming activities related to those initiatives. The compliance activities discussion section 320 may provide the project manager with communications with a compliance officer, administrator, and/or other entity. As illustrated, the sections 316-320 may be customizable by the project manager, based on the current state of one or more projects.

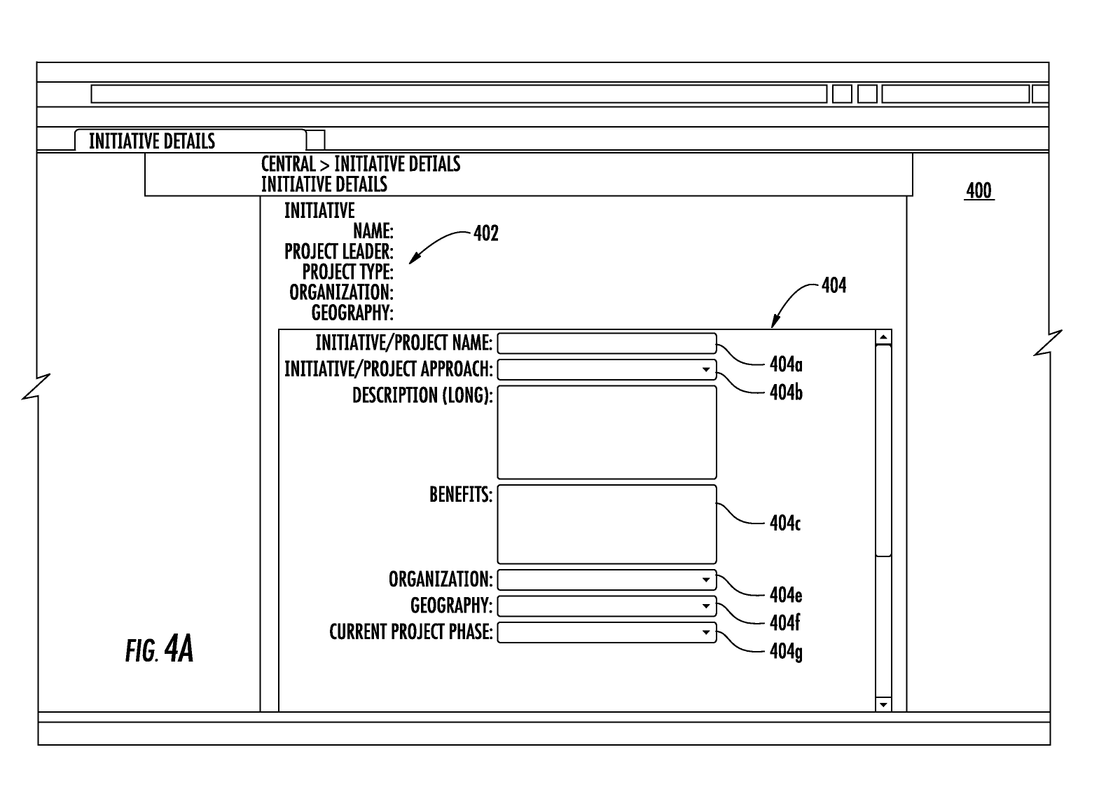

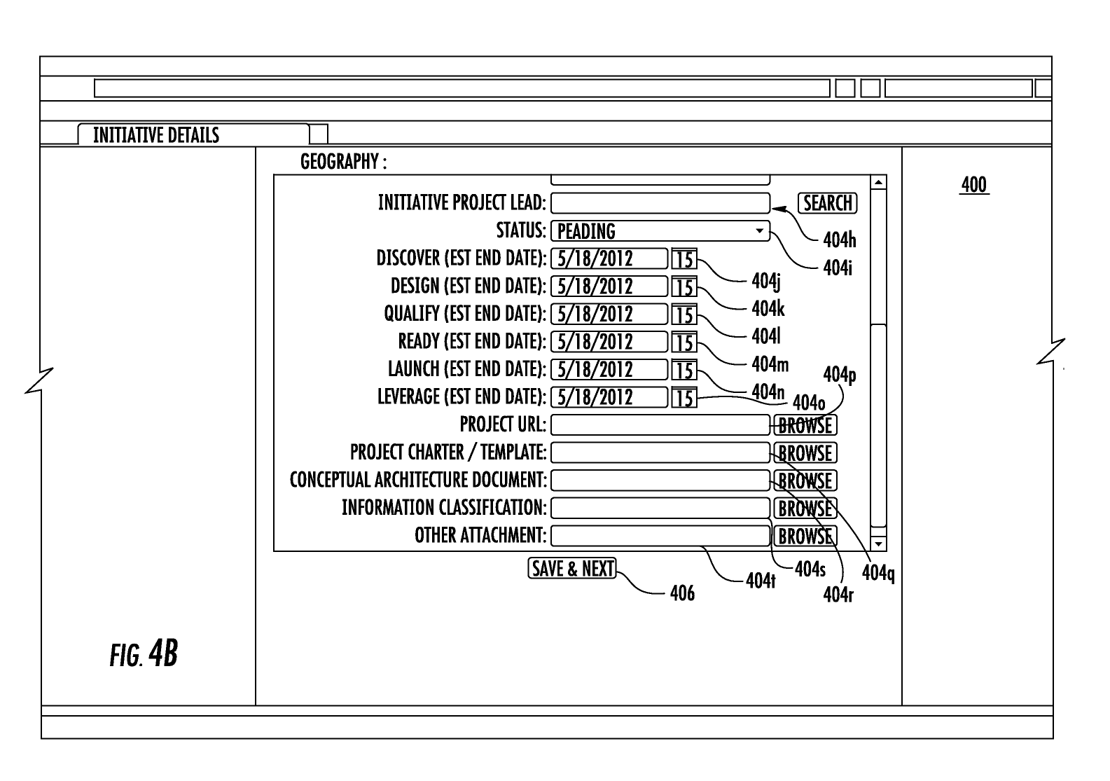

FIGS. 4A, 4B depict a project manager interface 400 for creating a project assessment, according to embodiments disclosed herein. In response to selection of create assessment option 314b in FIG. 3, the project manager interface 400 may be provided. The project manager interface 400 may be configured for the project manager to create a new project or initiative on the platform. Accordingly, the initiative section 402 may include a name, project leader, project type, organization, and a geographical area, which may be provided from the fields depicted in the project detail section 404. The fields may define a plurality of characteristics of the project.

The project detail section 404 includes a project name field 404a, a project approach field 404b, a description field 404c, a benefits field 404d, and an organization field 404e, a geographical area field 404f, a project phase field 404g. These are all configurable by the system administrator depending on the project methodology (approach) followed. For example, one methodology may have different phases and required documentation.

Continuing onto FIG. 4B, the project detail section 404 may additionally include a project lead field 404h, a compliance status field 404i, a discovery date field 404j, a design date 404k, a qualify date 404l, a ready date 404m, a launch date 404n, a leverage date 404o, a project URL field 404p, a project template field 404q, a conceptual architecture document field 404r, an information classification field 404s, and an additional assessment field 404t. A save option 406 is also provided.

As an example, the project manager may name the project in the project name filed 404a and may identify himself/herself and/or others as a project leader in the project approach field 404b. The project approach may be identified in the project approach field 404b. The organization field 404e may be populated with the organization for which the project is being created. In some embodiments, the platform may be provided for company employees of a single company that has multiple divisions, and the project manager may enter the company division for which the project is being performed. However, in some embodiments, the platform may be provided across multiple companies. In those embodiments, the project manager may input the company name. The geographical area of the project may also be input into the geographical area field 404f to identify the laws, regulations, corporate policies and/or known other hurdles or challenges that may apply. The current project phase (such as development, design, testing, etc.) may be input into the project phase field 404g.

Returning to FIG. 4B, the initiative project lead may be input into the project lead field 404h. The compliance status may be selected in the compliance status field 404i. In fields 404j-404o, the project manager may input the target dates for completing the discovery, design, quality, ready, launch, and leverage stages of the project or other phases, based on the project approach (methodology) used. Additionally, the project manager may input a uniform resource locator (URL) that is associated with the project in the project URL field 404p. In fields 404q-404t, the project manager may provide templates, documents, classification, and other attachments associated with the project for access at a later time. These attachments may take the form of one or more files that may be relevant to the project and/or one or more aspects of compliance.

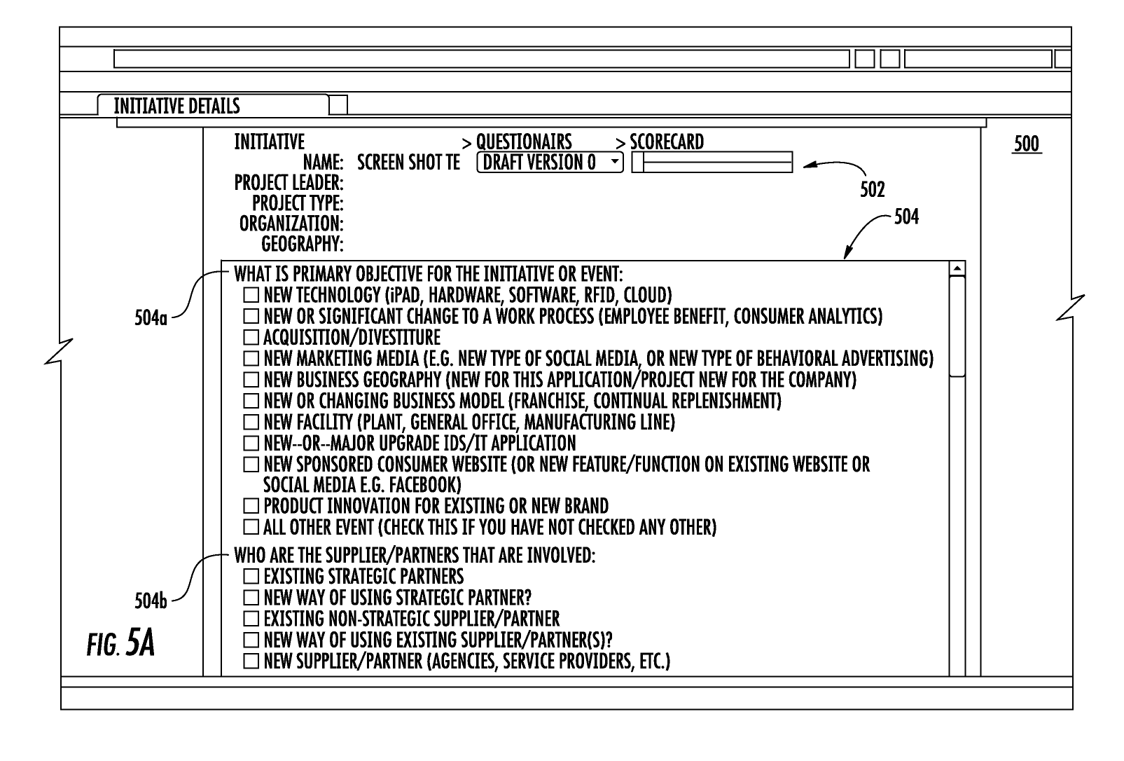

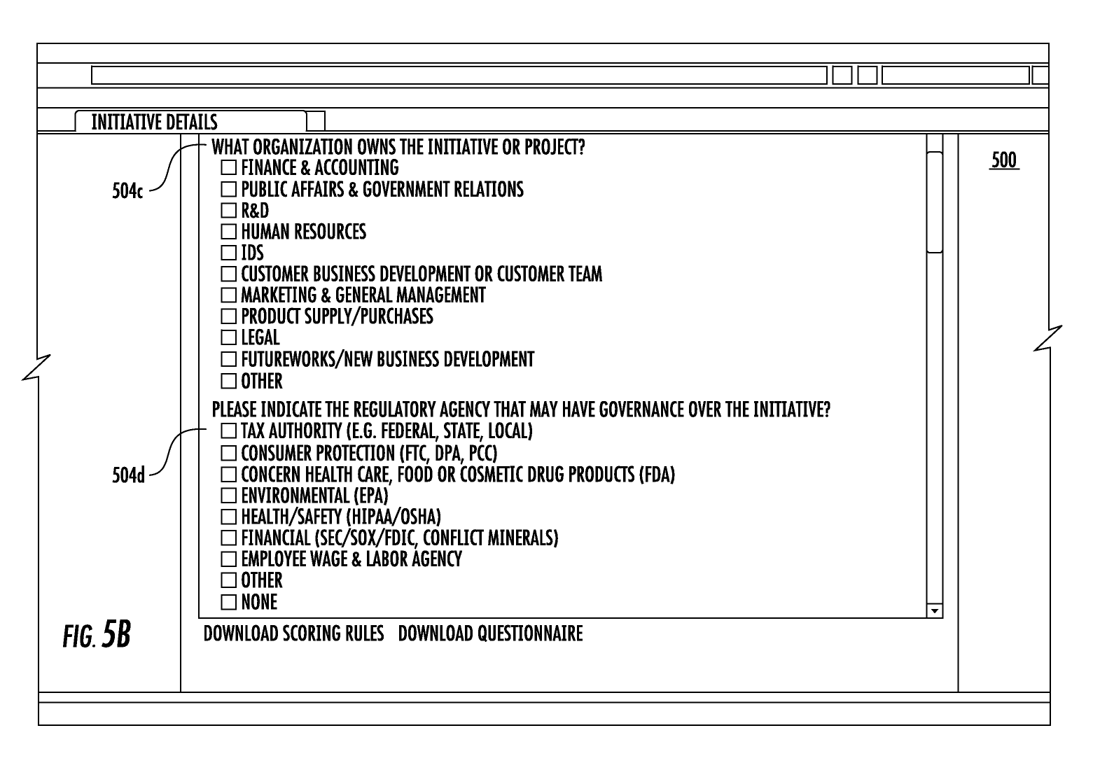

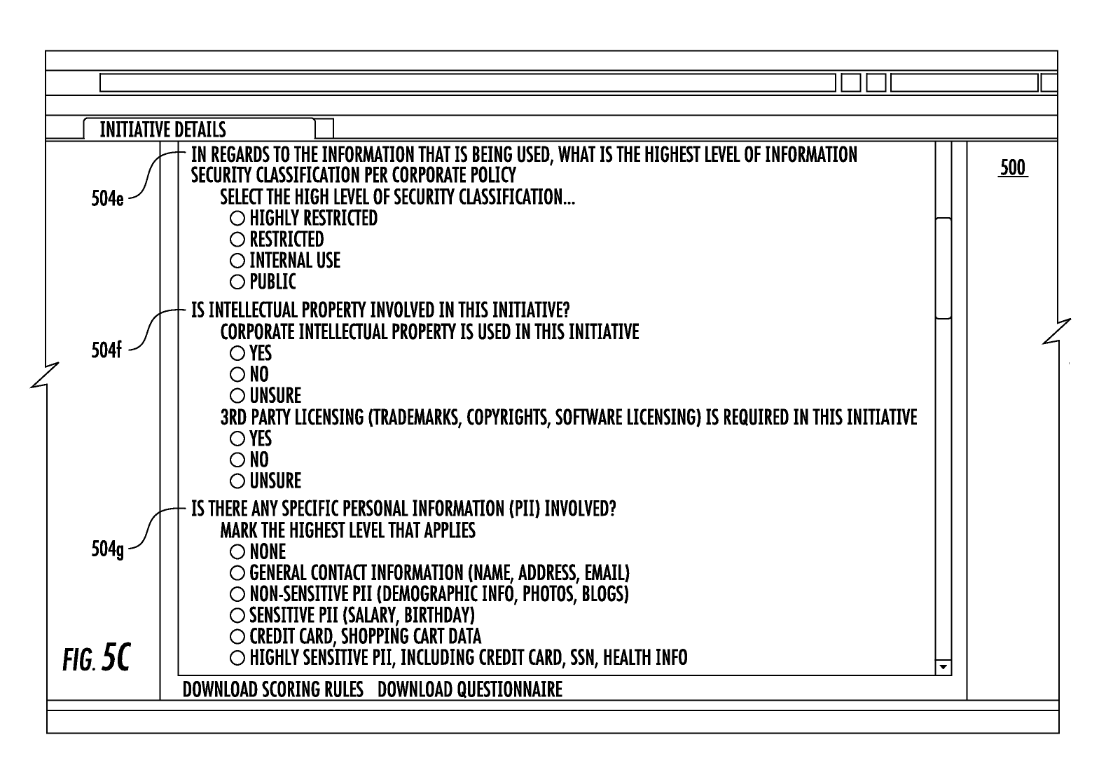

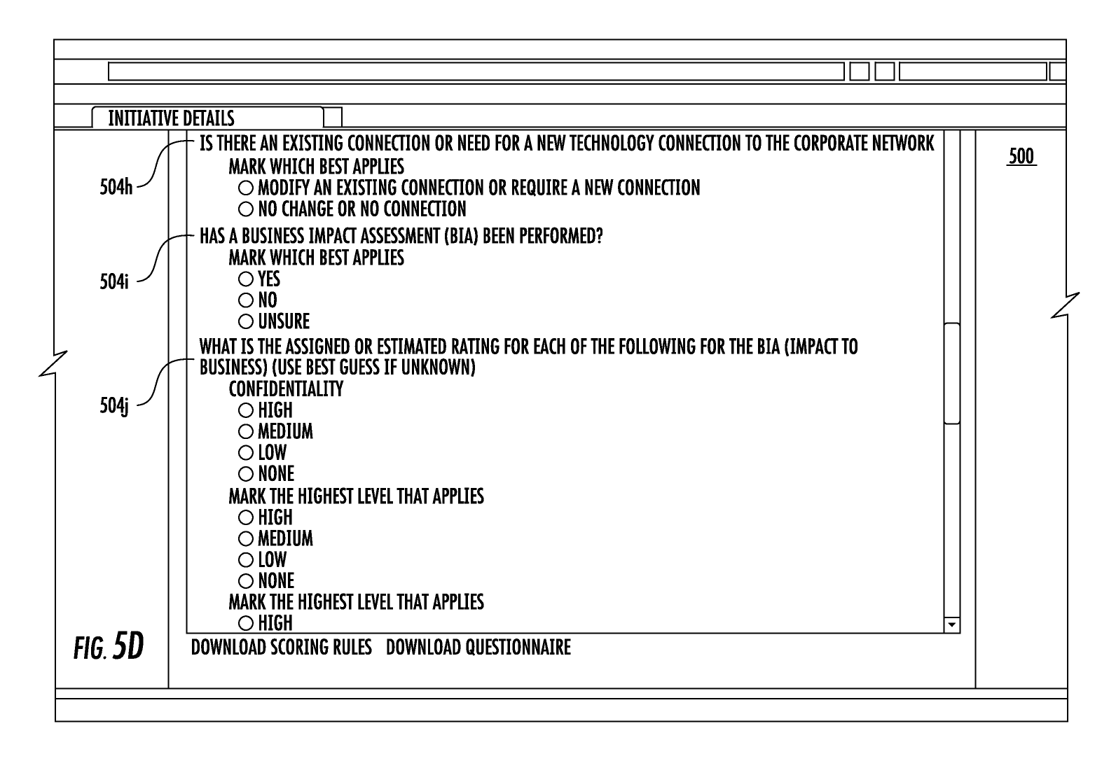

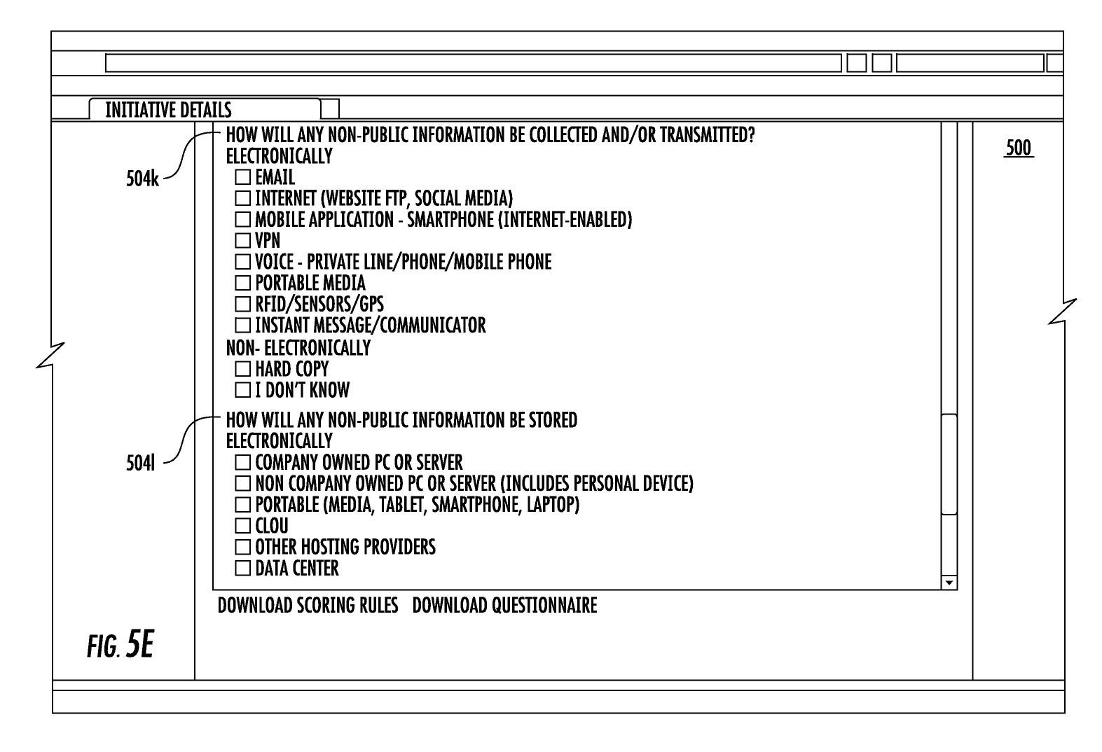

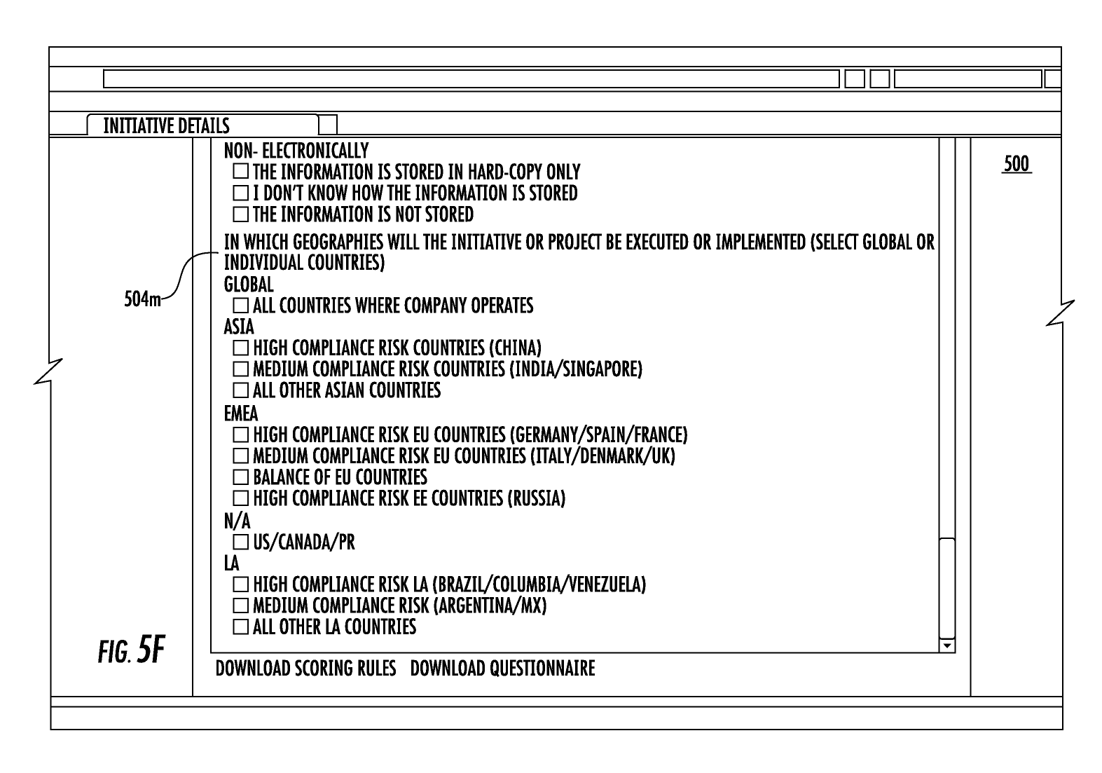

FIGS. 5A-5F depict a project manager interface 500 for providing a questionnaire for the project, according to embodiments disclosed herein. Specifically, in determining the types of compliance necessary for a particular project, the remote computing device 104 may provide a questionnaire that includes a one or more questions related to the project. Once the project manager has answered the questions, the remote computing device 104, the administrator device 102c, and/or the administrator may determine which compliance areas are present and thus, which compliance officers may be contacted to review the project.

Referring to FIG. 5A, the project manager interface 500 may include a project information section 502, which includes at least a portion of the data provided in FIGS. 4A and 4B. This information may include a project name, project leader, project type, organization, geographical area, etc. Also included is a questionnaire draft option (which may or may not be accessible by the project manager, as well as a scorecard for indicating a risk level and/or the overall risk assessment, based on the answers provided in the questionnaire and thus the amount of compliance necessary for completing the project.

Also included are a first question 504a and a second question 504b. As indicated, the first question 504a relates the primary objective for the project. The primary objective may include a new technology, new or changed work process, acquisition, new marketing media, new business geography, new or changed business model, new facility, new or upgraded information technology application, new website, new product innovation or brand, and/or other type of project. Similarly, the second question 504b relates to the suppliers and/or partners that will be involved in the project. As indicated, the options may include an existing strategic partner, a new way of using a strategic partner, an existing non-strategic supplier and/or partner, a new way of using an existing supplier and/or partner, and a new supplier and/or partner.

Similarly, in FIG. 5B, the project manager interface 500 may include questions 504c and 504d. The question 504c may relate to which organization owns the project. As indicated above, in some embodiments the company selected in organization field 404e from FIG. 4A may have a plurality of organizations within that corporate structure. Accordingly, the question 504c may be directed to identifying which of those organizations has an ownership interest in the project. Example organizations include finance and accounting, public affairs and government relations, research and development, human resources, IDS, customer business development or customer team, marketing and general management, product supply and purchases, legal, future works and new business development, etc. The question 504d may relate to the regulatory agency that may have governance over the project. Examples may include a tax authority, a consumer protection agency, a health care, food, cosmetic, or drug organization, environmental agency, health/safety agency, financial agency, employee wage and labor agency, and/or others.

In FIG. 5C, the project manager interface 500 may include questions 504e, 504f, and 504g. The question 504e relates to the level of security classification with which the project is protected. The question 504f relates to whether intellectual property is associated with the project. The question 504g relates to whether there is specific personal information involved in the project. The personal information may be received from users and/or customers of the eventual project. As an example, the personal information may include general contact information, non-sensitive personal information, sensitive personal data, credit card and other financial data, and highly sensitive data, such as social security numbers, and health information.

In FIG. 5D the project manager interface 500 may include questions 504h, 504i, and 504j. The question 504h relates to whether there is an existing connection or a need for a new connection to the company network. The question 504i relates to whether a business impact assessment has been performed. The question 504j relates to the estimated or assigned rating for the business impact assessments for confidentiality, availability, integrity, and/or other criteria.

In FIG. 5E, the project manager interface 500 may include questions 504k and 504l. The question 504k relates to how non-public information will be collected and/or transmitted in the project. Examples include both electronic solutions and non-electronic solutions, such as email, internet, mobile applications, virtual private network, voice communication, portable media, radio frequency identifier/sensors/global positioning, and instant messaging, hand copy, and/or other mechanisms for communicating information. The question 504l relates to how non-public information will be stored, both electronically and non-electronically. Examples include company-based storage, third party-based storage, portable storage, cloud storage, and/or other mechanisms for storage.

In FIG. 5F, the project manager interface 500 may include a question 504m, which relates to the geographies that the project will be implemented. As an example, the geographies may include all countries where the company operates, high risk countries, medium risk countries, and other countries on various continents. Also provided in FIG. 5F is a save option 506 for saving the answers and a submit option 508 for submitting the answers and creating the project on the platform.

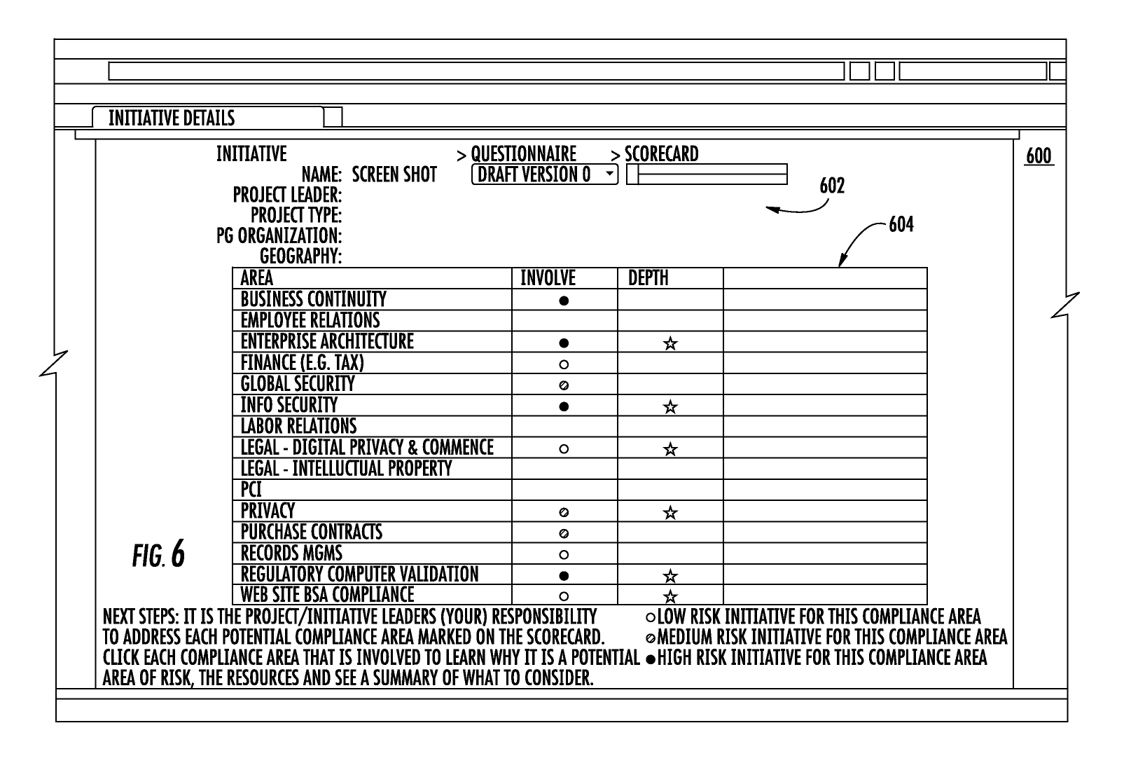

FIG. 6 depicts a project manager interface 600 for providing a project scorecard, according to embodiments disclosed herein. Specifically, once the project manager has completed the questionnaire from FIGS. 5A-5F, the project manager interface 600 may be provided, which identifies the compliance risk associated with the project. As illustrated, the project manager interface 600 may include an initiative section 602, which provides the information related to the project, as well as a questionnaire draft and a risk scorecard. Specifically, if the project manager decides that one of the answers has changed (either due to being incorrect or to a subsequent determination that the compliance risk is too high/low), he/she may reenter the questionnaire to change an answer. Accordingly, this change is reflected in the questionnaire section. Specifically, if a project manager submits an assessment and later changes that assessment (e.g., because the project manager learns something new about the project or because the project changes scope based on compliance requirements), the remote computing device 104 saves all previous versions. The scorecard may identify the overall risk for compliance with the project.

Also included is a risk area section 604, which identifies the areas of compliance that are involved in the project. The risk area section 604 also includes the level of risk for each of the identified compliance areas that are involved. Based on these areas, the remote computing device 104 can identify compliance officers that may be involved in ensuring that the project becomes compliant with those respective areas.

It should be understood that once the project manager has completed the questionnaire and receives the scorecard, some embodiments provide a “meeting-planning” feature that allows the project manager to organize a meeting of the appropriate compliance offers, design an agenda, and conduct a meeting. This helps assist project managers who are new to an area or learning a new business or technology.

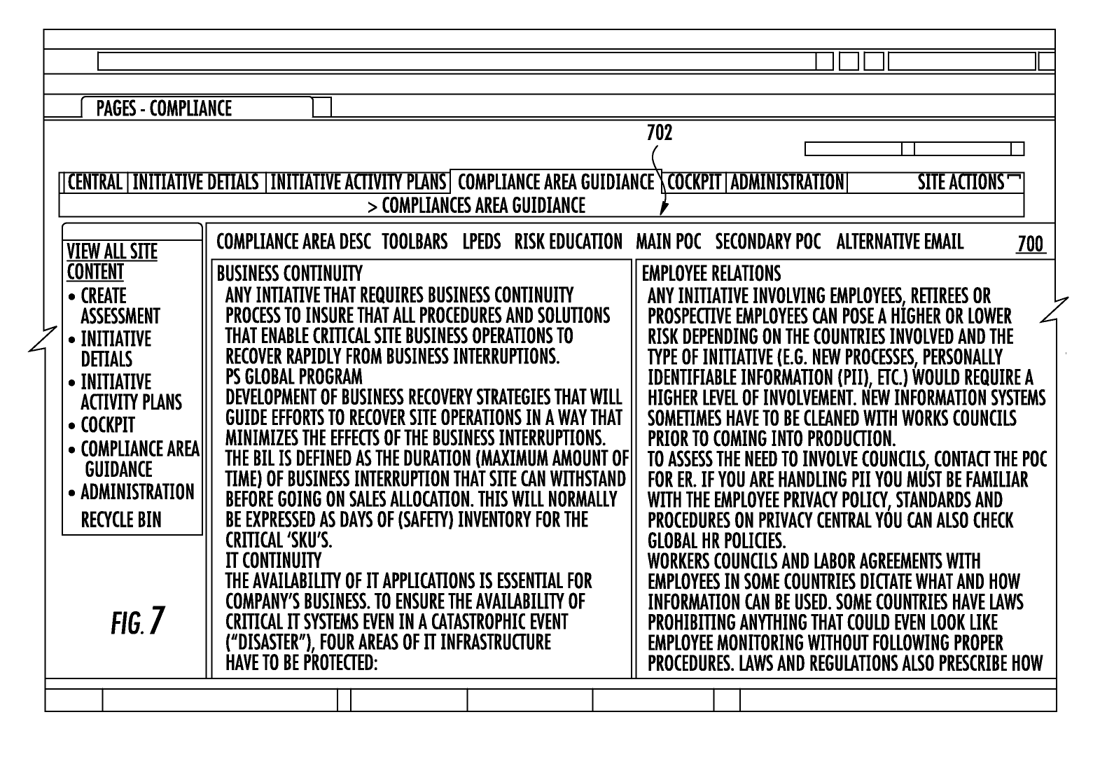

FIG. 7 depicts a project manager interface 700 for providing compliance guidance, according to embodiments disclosed herein. Specifically, once the questionnaire from FIGS. 5A-5F is completed, the remote computing device 104 may identify the areas where compliance may become an issue. Accordingly, the project manager interface 700 may be provided, such as in response to selection of the compliance area guidance tab 308 from FIG. 3. Regardless, in the guidance area 702, the project manager interface 700 may provide information and other guidance for meeting the compliance requirements for the compliance areas identified in FIG. 6. Specifically, as illustrated in FIG. 7, the project manager interface 700 may provide a summary of the compliance area (e.g., business continuity, employee relations), triggers for identifying this compliance area, a URL link associated with this compliance area, risk education, the compliance officers associated with the compliance area, and/or other information.

Specifically, the triggers may identify the reasons that the current project has been flagged as requiring compliance clearance for this compliance area. The URL link may provide a webpage, which may have additional information related to this compliance area. The risk education section may provide information regarding background information associated with the identified risk In one preferred embodiment, the risk area is explained in a video presentation or power point presentation which the project manager may access when convenient or helpful; this presentation provides a substantive overview or tutorial of the compliance risk area in subject matter provided from a compliance officer or other expert in the risk area.

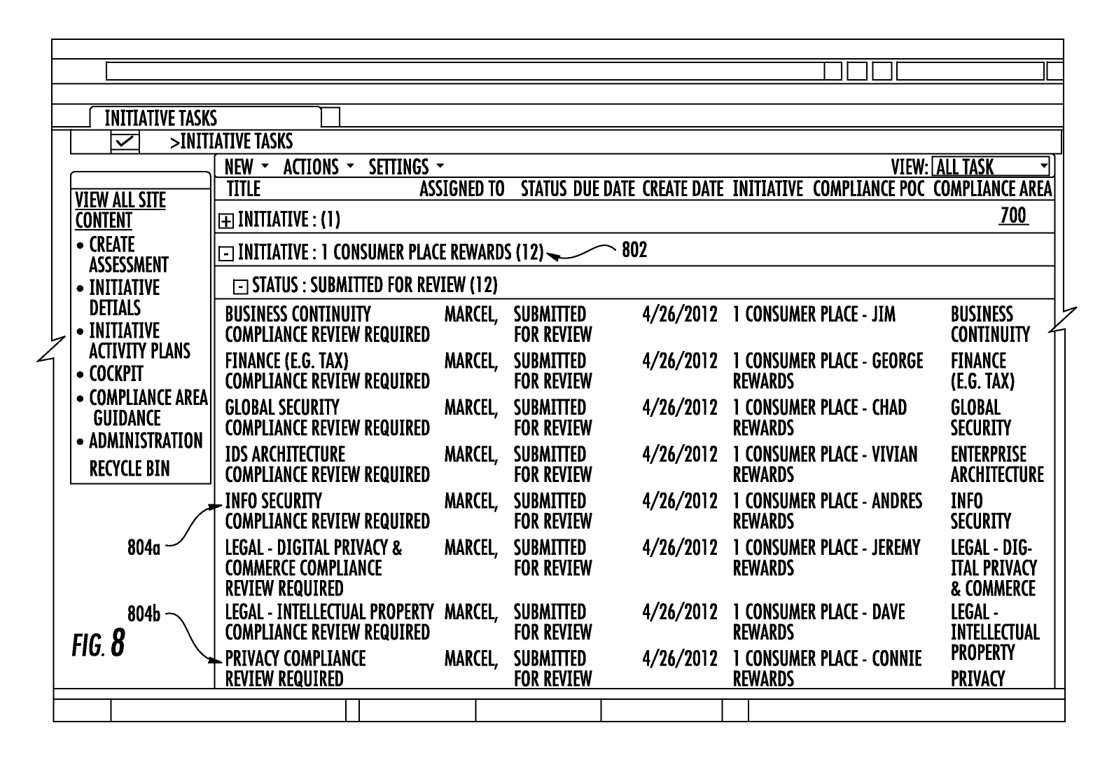

FIG. 8 depicts a project manager interface 800 for providing initiative activity plans, according to embodiments disclosed herein. In response to selection of the initiative activity plans tab 306 from FIG. 3, the project manager interface 800 may be provided. The project manager interface 800 may include a compliance area section 802, which provides a listing of the compliance areas that were initially identified in the risk area section 604 of FIG. 6. The compliance area section 802 includes links to each of the each of the compliance areas 804a, 804b, as well as the project owner, current status, date of status, compliance officer, and/or other information related to the identified compliance areas, which need to be completed before compliance of the project will be granted.

Upon the project manager answering the questions, the remote computing device 104 may determine the compliance areas that apply to the project and utilize the preconfigured scoring model to assess the compliance risk. The remote computing device 104 may additionally determine the compliance officers that will assist the project manager with the project. The remote computing device 104 and/or the compliance officers may additionally determine at least one policy for compliance within the compliance area. From the policy, standards, procedures, and/or guidelines may be determined for complying with the policy. The compliance officer may thus send the project manager the information for complying with the policy.

Depending on the particular embodiment, the policy may include a regulation, a statute, case law, an internal business policy, an internal legal policy, and/or other constraint to which the project must comply, along with standards and/or procedure guidelines to become compliant. Additionally, some compliance areas may include a single policy for conformance, while other compliance areas may include more than one policy.

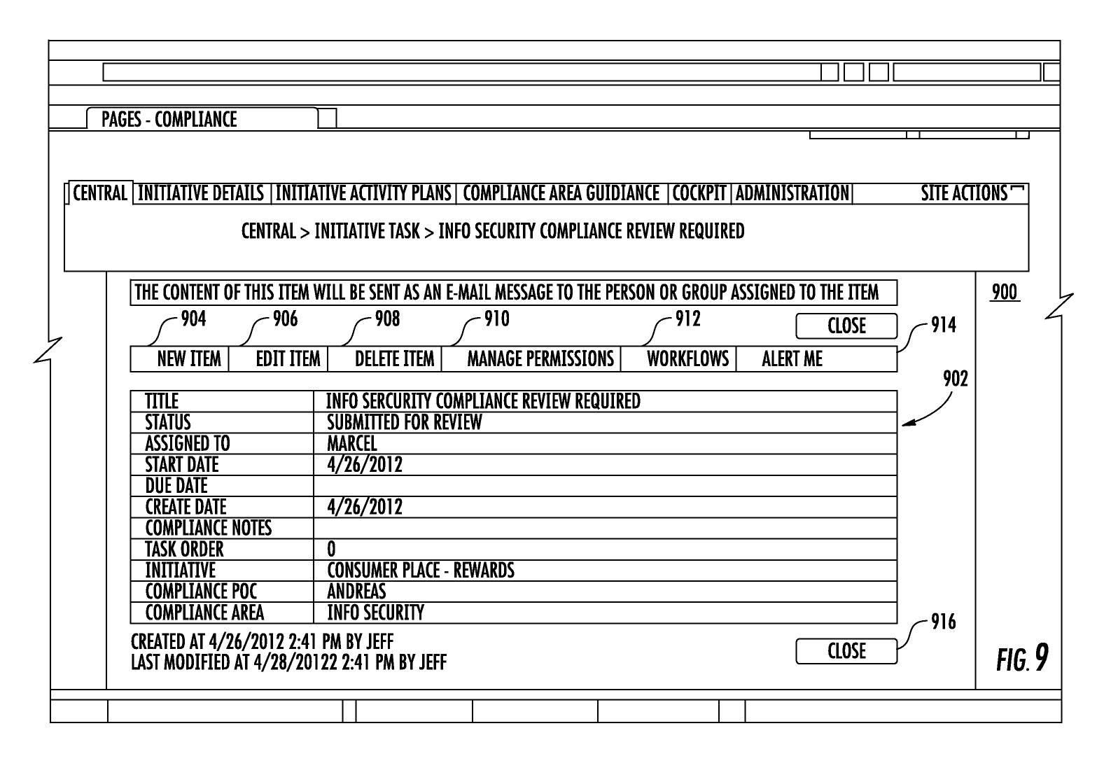

FIG. 9 depicts a project manager interface 900 for providing an activity plan detail, according to embodiments disclosed herein. Specifically, in some embodiments, the project manager interface 900 may be provided as an electronic communication, such as an email. The project manager interface 900 may include a data area 902, which includes a plurality of data fields including, a title, status, assignment, start date, due date, create data, compliance notes, task order, initiative, compliance officer, and compliance area.

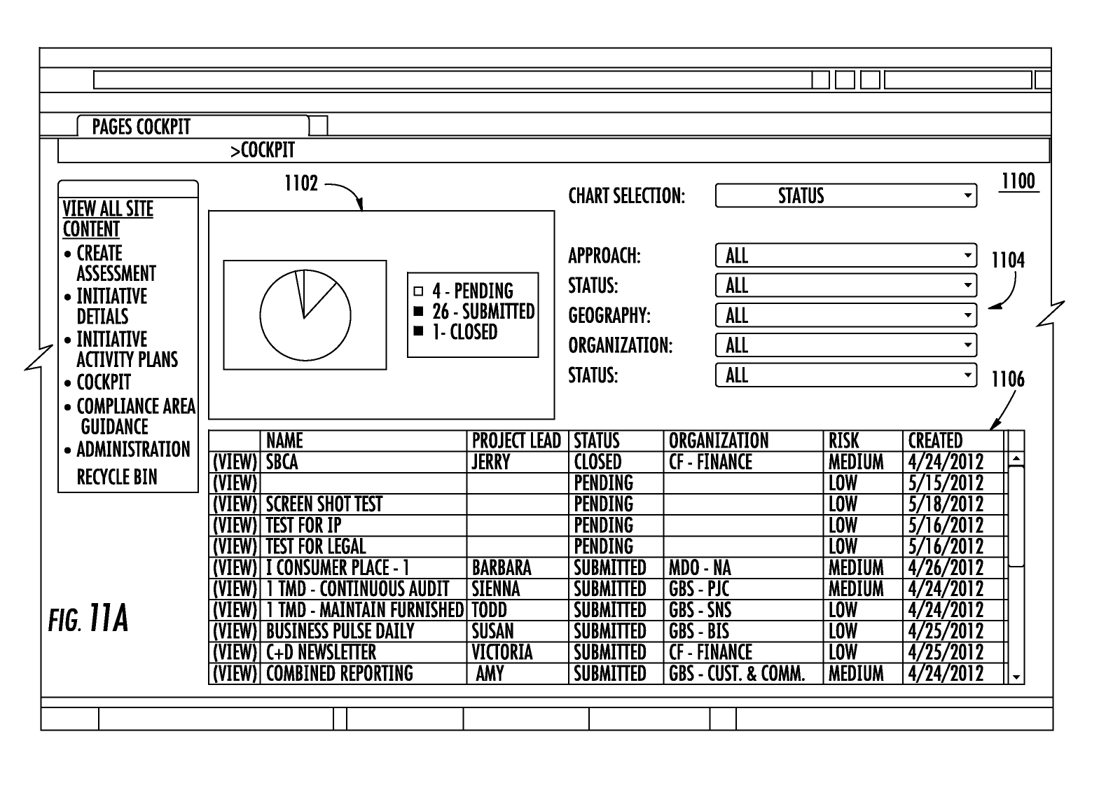

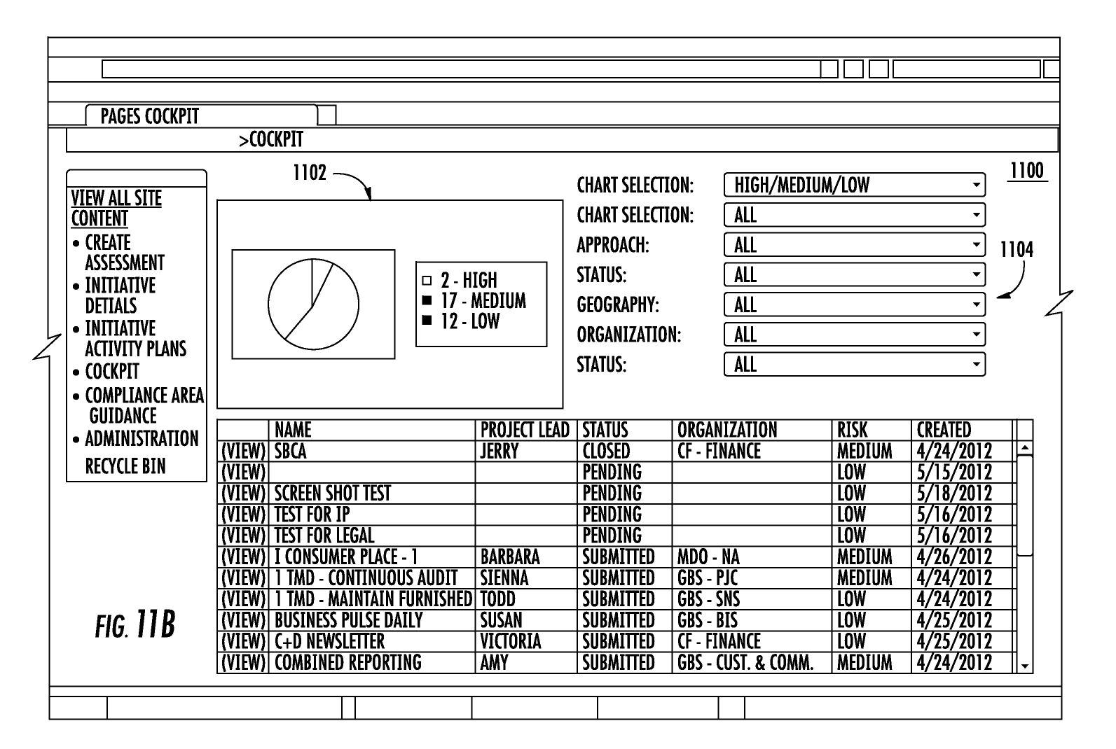

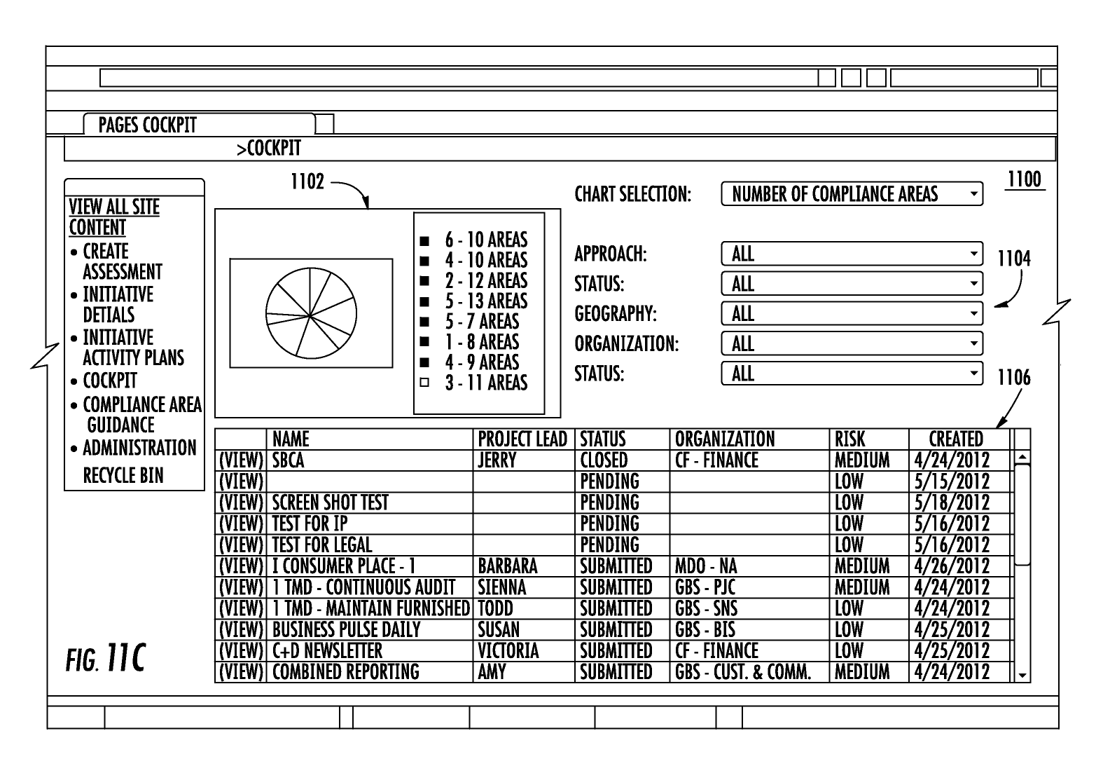

Also included is a new item option 904, an edit item option 906, a delete item option 908, a manage permissions option 910, a workflow option 912, and an alert option 914, and a close option 916. In response to selection of the new item option 904, a new project may be created. In response to selection of the edit item option 906, the current project may be edited to indicate the progress that has been completed in the project, assign a task to another person, etc. In response to selection of the delete item option 908, the current project may be deleted. In response to the manage permissions option 910, permissions related to the current project may be edited. In response to selection of the workflow option 912, the cockpit depicted in FIGS. 11A-11C may be provided. Similarly, in response to selection of the alert option 914, the project manager may manage alerts. The close option 916 may be selected to initiate an electronic message to the compliance officer, who may then respond using a similar messaging mechanism. The dialog between the project manager and the compliance officer may be captured and stored by the remote computing device for future reference on the platform.

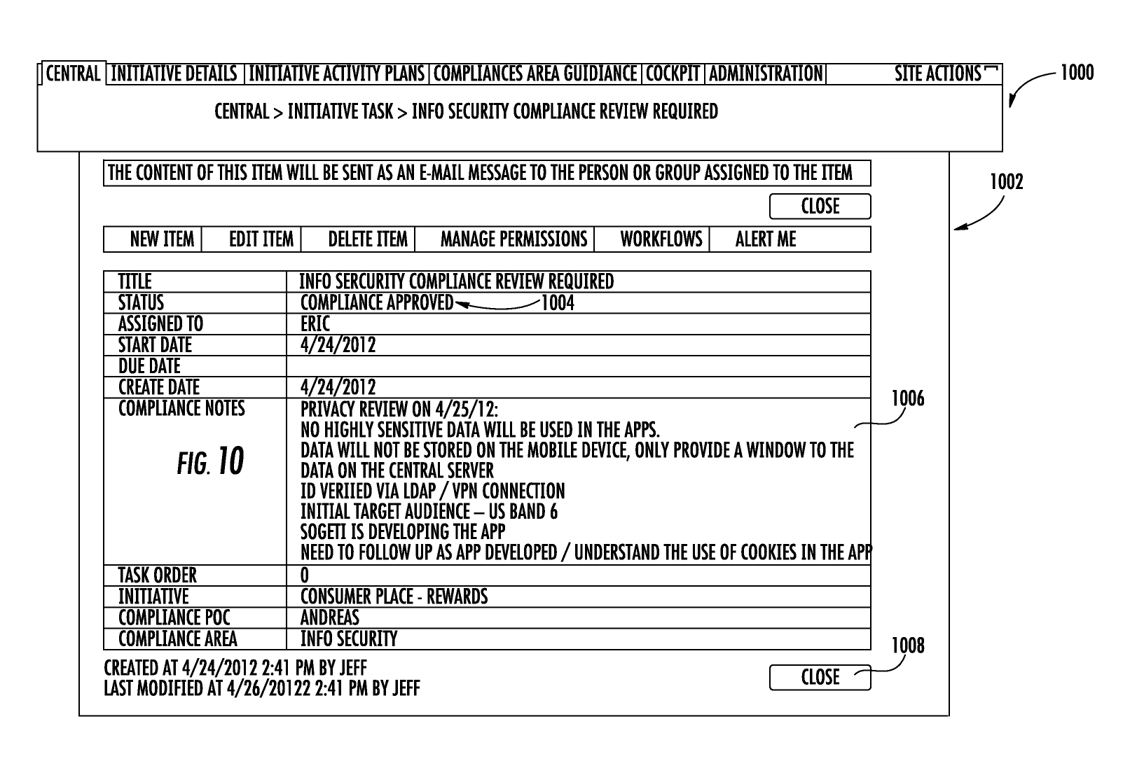

FIG. 10 depicts another project manager interface 1000 for providing an activity plan detail, according to embodiments disclosed herein. Specifically, while the project manager interface 900 from FIG. 9 depicts information on a compliance area that is not complete, the project manager interface 1000 provides information related to a compliance area that has been completed. Specifically, the project manager interface 1000 includes an information area 1002, which includes a plurality of data fields including, a title, status, assignment, start date, due date, create data, compliance notes, task order, initiative, compliance officer, and compliance area. While the project manager interface 900 in FIG. 9 indicates that the status of the compliance area is “submitted for review,” the status 1004 identified in the project manager interface 1000 is “compliance approved.” Because compliance has been achieved, one or more communications between the project manager and the compliance officer has already occurred. Accordingly, those previous communications are identified in the compliance notes section 1006. Also included is a close option 1008. In response to selection of the close option 1008, the remote computing device 104 may determine whether additional communications are to be sent between the compliance officer and the project manager. If so, the appropriate correspondence is sent.

It should be understood that while the embodiments of FIGS. 9 and 10 are illustrated as project manager interfaces 900, 1000, these are merely examples. Specifically, a compliance officer interface may be provided with a communication interface that is similar to the project manager interfaces 900, 1000, to provide a mechanism for the project manager and the compliance officer to communicate. Additionally, because the communications are stored by the remote computing device 104, either the project manager or the compliance officer may access the communication at a later time by accessing the platform described herein. Similarly, the interfaces of FIGS. 9 and 10 may be configured to facilitate communication between (or among) compliance officers of different compliance areas that are assigned to the same project. As an example, if two (or more) compliance areas overlap, compliance officers may utilize the interfaces of FIGS. 9 and 10 to communicate and exchange documentation, to ensure that unnecessary compliance redundancy does not occur. As also discussed herein, embodiments may be configured to archive a plurality of different versions of the project, if certain aspects of the project changes.

FIGS. 11A-11C depict a compliance officer interface 1100 for providing a central cockpit of project data, according to embodiments disclosed herein. Specifically, while the project manager may have access to view all compliance areas associated with a project, the compliance officers may have access only to those compliance areas in which they are involved. Accordingly, the cockpit may relate to various projects of the compliance area where the compliance officer has been assigned. Accordingly, the compliance officer interface 1100 may provide a graphical area 1102, a graph selector area 1104, and a project area 1106. The graphical area 1102 may provide a graphical representation of the projects and their current status. By altering one or more options in the graph selector area 1104, the compliance officer may alter the graphical area 1102 to depict projects based on other criteria, such an owner, risk, date, compliance area, number of compliance areas, geography, organization, compliance status, etc. By selecting a sector of the graphical area 1102, additional information related to the selected sector may be provided. Similarly, the compliance officer may be provided with additional information related to projects by selecting one or more of the projects in the project area 1106.

As illustrated in FIG. 11B, the compliance officer may select the chart selection option in the graph selector area 1104 to provide the projects according to risk. Accordingly, the graphical area 1102 may change to show the corresponding data. Similarly, FIG. 11C depicts the graphical area 1102 according to the number of compliance areas for a project. Specifically, in response to altering the chart selection option in the graph selector area 1104, the graphical area 1102 may provide to show the corresponding data.

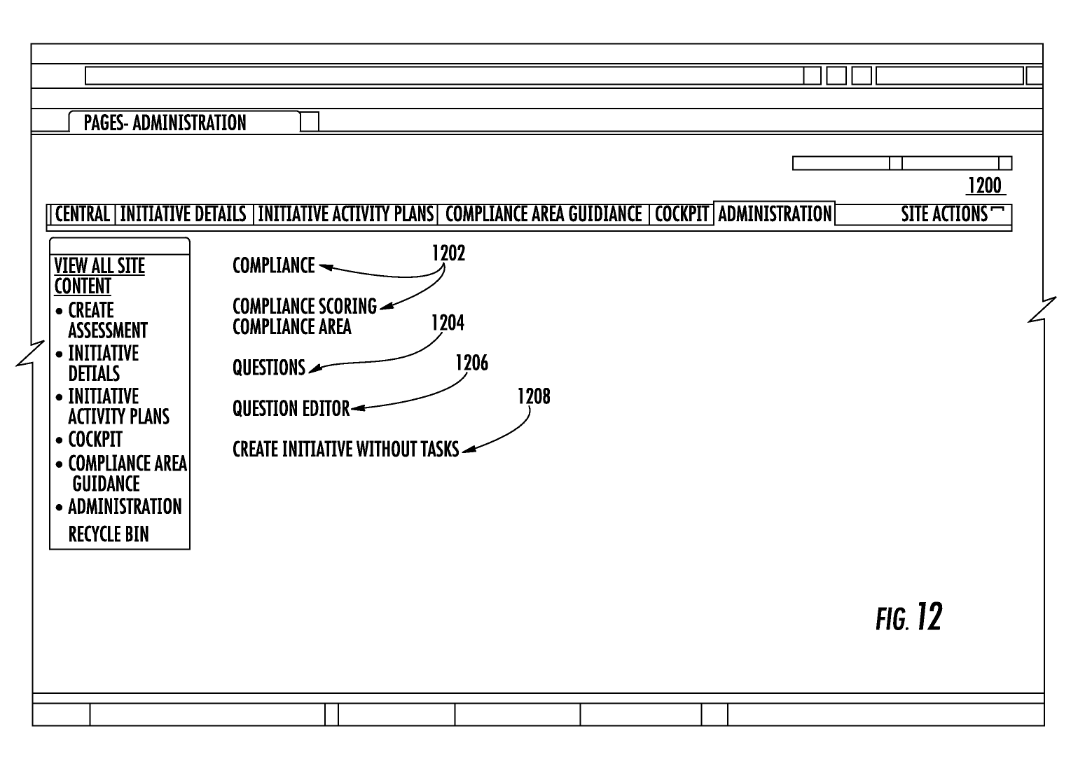

FIG. 12 depicts an administrator interface 1200 for managing components of project compliance, according to embodiments disclosed herein. Upon authenticating with administrator privileges and selecting administration tab 312 from FIG. 3, the administrator interface 1200 may be provided. The administrator interface 1200 may include compliance options and question options. Specifically, the administrator interface 1200 provides a compliance scoring option 1202, a compliance area option 1204, a question editor option 1206, and a create initiative option 1208. In response to selection of the compliance scoring option 1202, the factors and weights utilized for determining compliance risk may be determined and whether a compliance officer is to be involved. In response to selection of the compliance area option 1204, the criteria for selecting a compliance area may be altered. In response to selection of the question editor option 1206, the questions utilized to identify the compliance risk may be altered. In response to selection of the create initiative option 1208, options related to creating a new project may be altered.

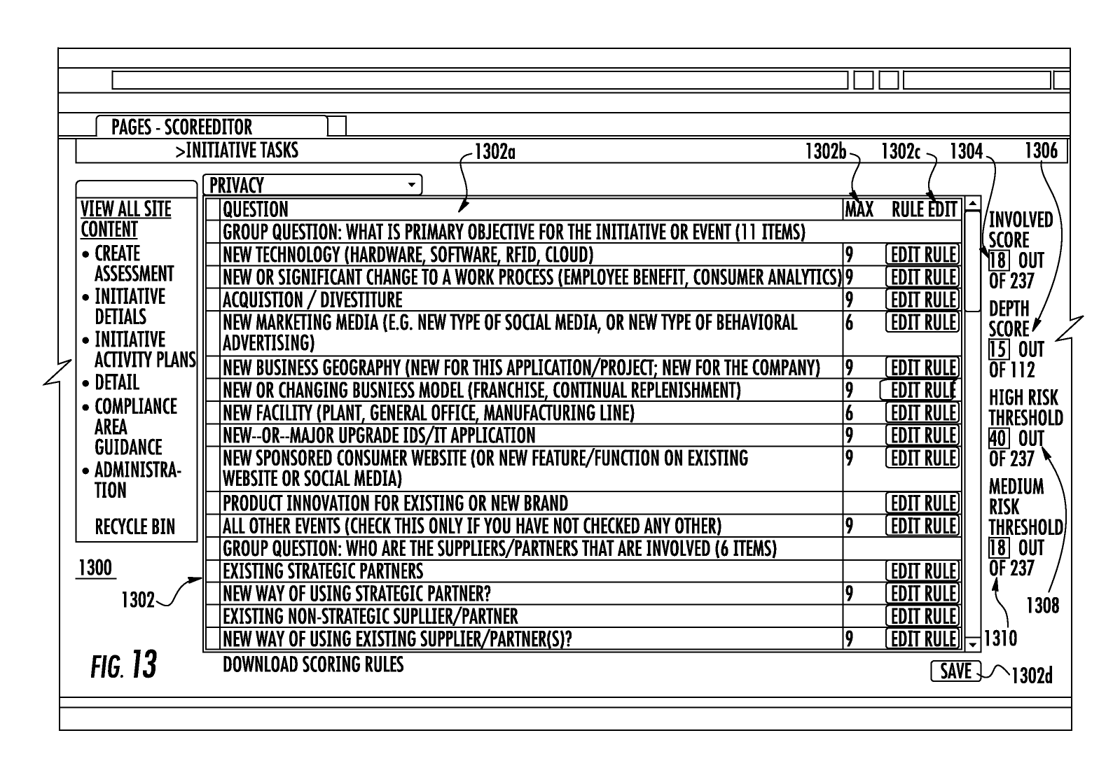

FIG. 13 depicts an administrator interface 1300 for managing compliance scoring of the questionnaire, according to embodiments disclosed herein. In response to selection of the compliance scoring option 1202 from FIG. 12, the administrator interface 1300 may be provided. Specifically, the administrator interface 1300 includes a question area 1302, which includes questions 1302a, maximum scores options 1302b, rules options 1302c, and a save option 1302d. The administrator interface 1300 also includes an involved score option 1304, a depth score option 1306, a high risk threshold option 1308, and a medium risk threshold option 1310 for altering a scoring characteristic of a question.

By selecting one of the maximum scores options 1302b, the administrator can alter the maximum risk score that a question can achieve. Similarly, by selecting the rules options 1302c, the administrator can alter the rules associated with scoring the question. The involved score option 1304 may be selected to allow the administrator to specify the score value associated with an involved score. The administrator may similarly specify the score value associated with a depth score in the depth score option 1306. The administrator can specify the high risk threshold score with the high risk threshold option 1308. The administrator can further specify the medium risk threshold score with the medium risk threshold option 1310.

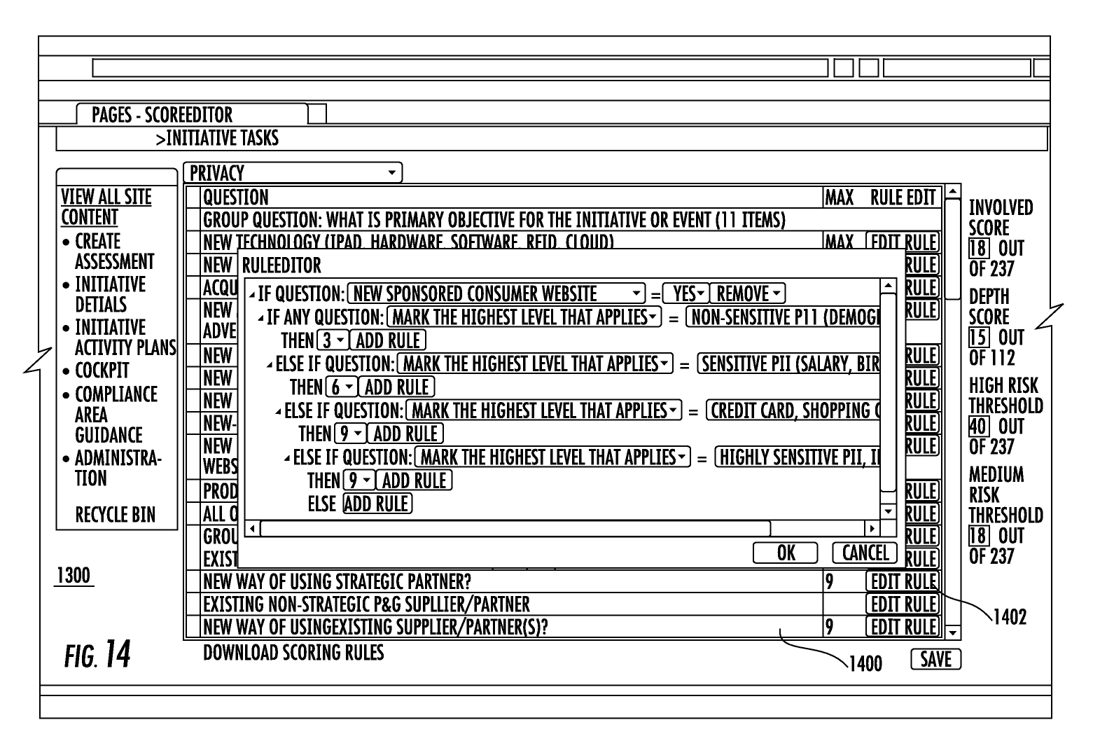

FIG. 14 depicts an administrator interface 1400 for creating, removing, and/or editing a rule, according to embodiments disclosed herein. In response to selection of the one of the rules option 1302c, from FIG. 13, the administrator interface 1400 may be provided to edit the scoring rule associated with the question. Specifically, the administrator interface 1400 may include one or more if-then criteria for assigning a score, based on the responses given by the project manager. Based on the selections made in the administrator interface 1400, a project may be scored, as described above. Other mechanisms for determining a question and/or answer score may also be implemented.

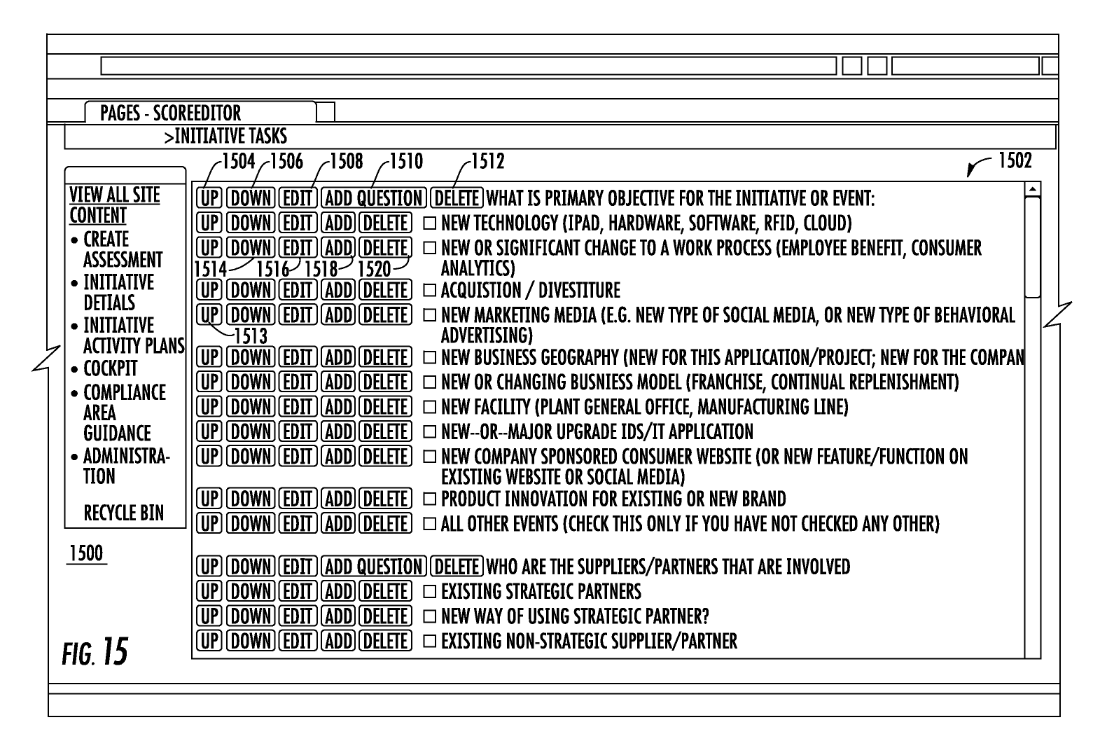

FIG. 15 depicts an administrator interface 1500 for editing questions of the questionnaire, according to embodiments disclosed herein. In response to selection of the question editor option 1206 from FIG. 12, the administrator interface 1500 may be provided. Specifically, the administrator interface 1500 may include a question area 1502 that includes a plurality of options for editing the question provided when the project manager is creating a new project or initiative. The options may include a move up option 1504, a move down option 1506, an edit option 1508, and add question option 1510, and a delete option 1512. By selecting the move up option 1504 or the move down option, the question may change position relative to other questions. Selection of the edit option 1508 may provide a text prompt for the administrator to alter the question text. Selection of the add question option 1510 provides the administrator with a window for adding a new question. The delete option 1512 may be selected to delete the question and corresponding answers from display. Similarly, each of the answers may have similar options, such as an up option 1513, a down option 1514, an edit option 1516, and add option 1518, and a delete option 1520 for performing similar functionality. However, the delete option 1520 only deletes the selected answer.

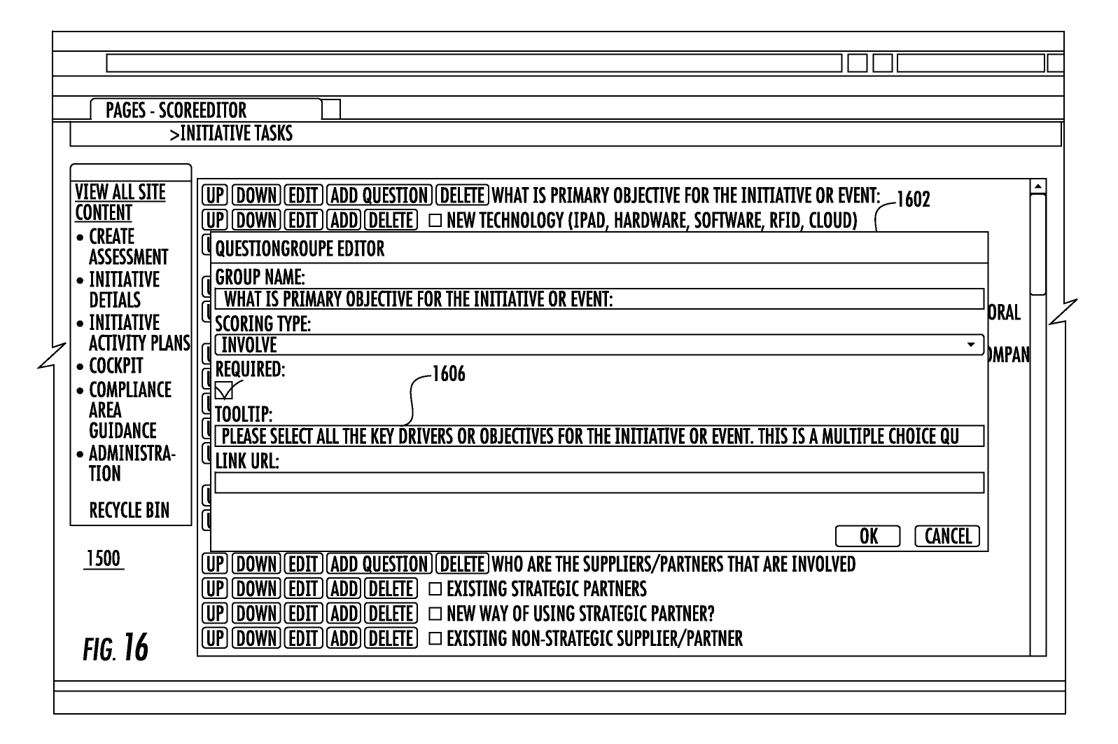

FIG. 16 depicts an administrator interface 1600 for editing a group of questions in the questionnaire, according to embodiments disclosed herein. In response to selection of the edit option 1508, the administrator interface 1600 may be provided. Specifically, the administrator interface 1600 may include a group name text box 1602, a scoring type option 1604, a tooltip text box 1606, and a link URL text box 1608. The group name text box 1602 may receive administrator input for altering the selected question. Similarly, the scoring type may be altered according to the selection from the scoring type option 1604. As an example, an involve scoring type may be provided, as well as a depth scoring type. Other scoring types may also be provided. The tooltip text box 1606 may receive additional text for providing the project manager with additional information regarding the question. This additional information may be provided by the project manager hovering a cursor over a predetermined area around the question. The link URL text box 1608 may provide the project manager with information for websites that may include additional information.

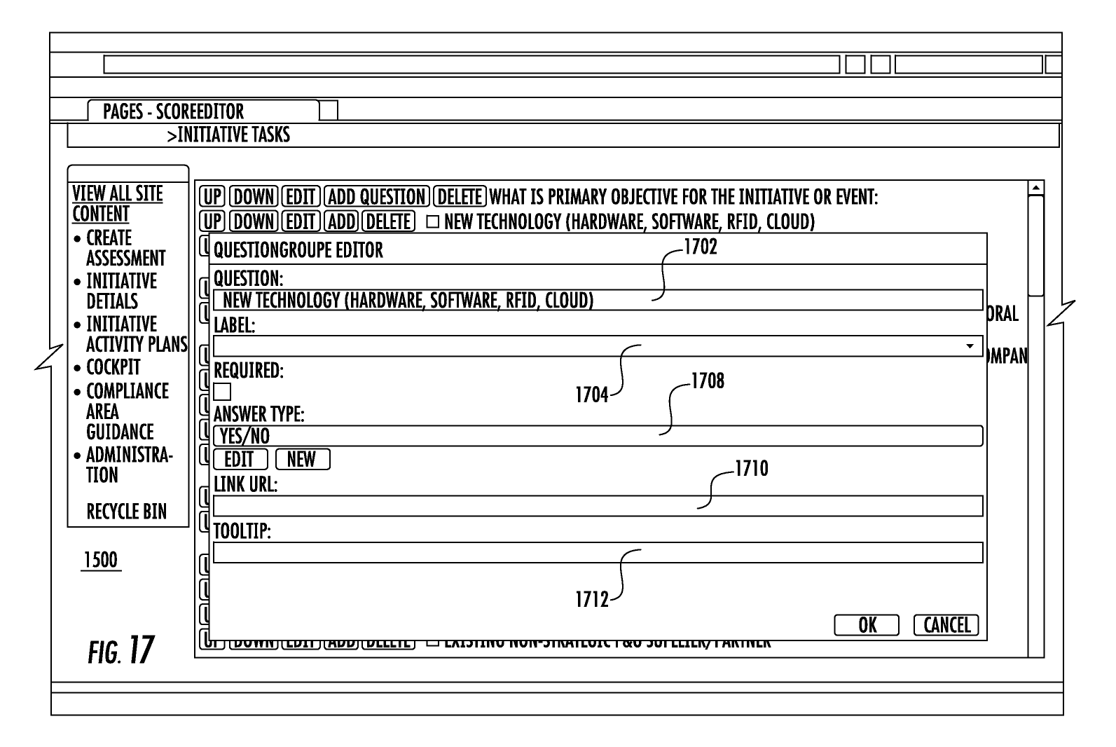

FIG. 17 depicts an administrator interface 1700 for editing an individual question in the questionnaire, according to embodiments disclosed herein. In response to selection of the edit option 1516 from FIG. 15, the administrator interface 1700 may be provided. Specifically, while the administrator interface 1600 from FIG. 16 related to editing a question, the administrator interface 1700 relates to editing an answer. As illustrated, the answer text box 1702 may provide the administrator with the ability to edit the answer associated with the question. The label text box 1704 may be utilized for editing a label associated with the answer. The answer type option 1708 may indicate whether the answer is a yes/no answer, a checkbox, a radio button, or other type of answer. Options for adding, removing, and/or editing the answer types may also be provided. Also included is a link URL text box 1710 and a tooltip text box 1712.

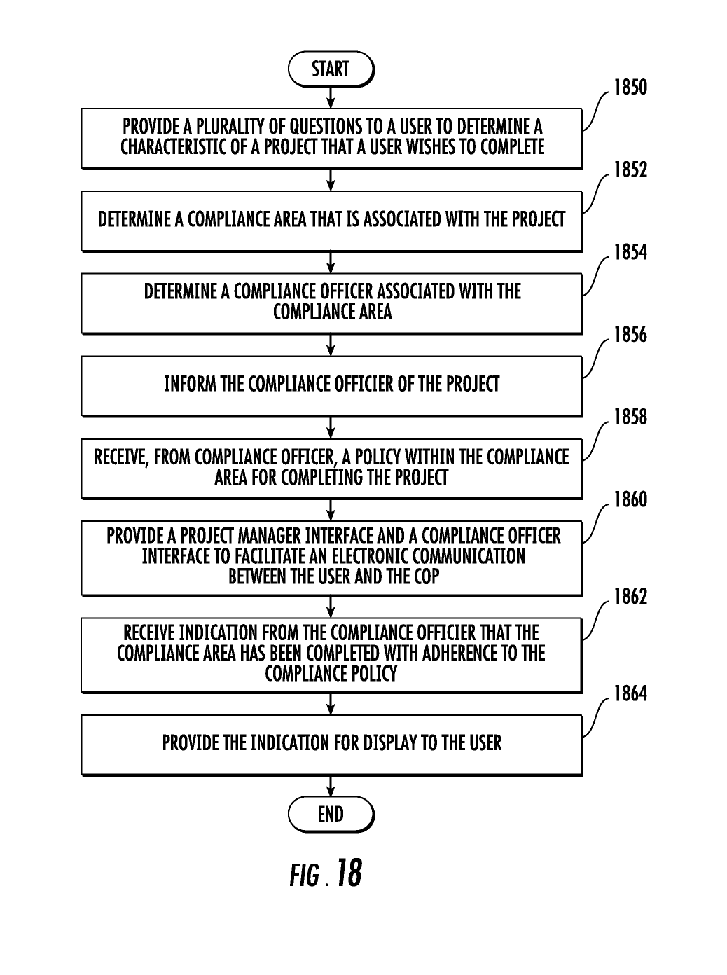

FIG. 18 depicts a flowchart for providing information compliance risk assessment, according to embodiments disclosed herein. As illustrated in block 1850, a plurality of questions may be provided to a user, such as a project manager, to determine a characteristic of a project the user wishes to complete. The questions may be accessed from the memory component 140 (FIGS. 1 and 2) and/or the data storage component 236 (FIG. 2). The questions may then be sent via the input/output hardware 232 to the project manager device 102a. In block 1852, a compliance area that is associated with the project may be determined. This determination may include receiving the answers from the project manager device 102a and then utilizing the compliance logic 144b, the project data 238a, and/or the compliance data 238b to determine the features of compliance and determine into which compliance areas the project falls. In block 1854, a compliance officer that is associated with the compliance area may be determined. This determination may be made by accessing the compliance data 238b to access compliance officers and compare those with the compliance areas associated with the project. In block 1856, the compliance officer is informed of the project. In block 1858, a policy within the compliance area may be received from the compliance officer. In block 1560, a project manager interface and a compliance officer interface are provided to the user and compliance officer, respectively to facilitate an electronic communication between the user and the compliance officer. These interfaces may be accessed from the memory component 140 and/or data storage 236 and then sent to the respective parties. In block 1862, an indication may be received from the compliance officer that the compliance area has been completed with adherence to the policy. In block 1864, the indication of adherence may be provided for display to the user.

It should be understood that while reference has been made herein to a project manager, this term may include other users that have access to the platform for the purpose of viewing, adding, editing, and/or otherwise managing a project. Similarly, while reference has been made to compliance officers, this may also include any personnel, such as compliance subject matter experts, who may access the platform for viewing, commenting, and/or otherwise managing compliance of a compliance area for one or more projects.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for compliance risk assessment comprising:
a memory component that stores a program that, when executed by a processor, causes the system to perform at least the following:
provide a plurality of questions to a user to determine a characteristic of a project that a user wishes to perform;
determine, from the characteristic, a compliance area that is associated with the project;
determine a compliance officer associated with the compliance area to assist in completing the project;
inform the compliance officer of the project;
determine a policy within the compliance area for completing the project;
receive an indication of compliance with the policy from the user;
provide the compliance officer with access to the indication of compliance and an option to indicate that the compliance area has been completed with adherence to the policy;
receive conformation from the compliance officer that the compliance area has been completed with adherence to the policy; and
provide the indication to the user for display.

2. The system of claim 1 wherein the risk assessment relates to compliance when information is handled.

3. The system of claim 1, wherein the program further causes the system to provide an interface for facilitating an electronic communication between the user and the compliance officer.

4. The system of claim 1, wherein the program further causes the system to provide a compliance officer interface for providing information on the project and information on a different project, wherein the project and the different project are both associated with the compliance area.

5. The system of claim 4, wherein the compliance officer interface further comprises a graphical area for providing a graphical representation of the information on the project and the information on the different project.

6. The system of claim 1, wherein the program further causes the system to provide an administrator interface for altering at least one of the following: a question provided to the user, an answer provided to the user, and a scoring characteristic of the question.

7. The system of claim 1, wherein the program further causes the system to provide a project manager interface that includes fields for the user to define characteristics of the project.

8. The system of claim 1, wherein the program further causes the system to provide a scorecard to a project manager that identifies an overall risk level of the project with respect to the compliance area and a different compliance area identified that is involved in the project given the compliance area risk level of the compliance area and the different compliance area.

9. A non-transitory computer-readable medium for compliance risk assessment that includes logic that, when executed by a computing device, causes the computing device to perform at least the following:
provide a plurality of questions to a project manager to determine a characteristic of a project that a project manager wishes to perform;
determine, from the characteristic, a compliance area that is associated with the project;
determine a compliance officer associated with the compliance area to assist in completing the project;
receive, from the compliance officer, a policy within the compliance area for completing the project;
facilitate an electronic communication between the project manager and the compliance officer;
receive an indication from the compliance officer that the compliance area has been completed with adherence to the policy; and
provide the indication to the project manager for display.

10. The non-transitory computer-readable medium of claim 9, where in compliance risk area includes the handling of information.

11. The non-transitory computer-readable medium of claim 9, wherein the logic further causes the computing device to provide an interface for facilitating the electronic communication between the project manager and the compliance officer.

12. The non-transitory computer-readable medium of claim 9, wherein the logic further causes the computing device to provide a compliance officer interface for providing information on the project and information on a different project, wherein the project and the different project are both associated with the compliance area.

13. The non-transitory computer-readable medium of claim 12, wherein the compliance officer interface further comprises a graphical area for providing a graphical representation of the information on the project and the information on the different project.

14. The non-transitory computer-readable medium of claim 9, wherein the logic further causes the computing device to provide an administrator interface for altering at least one of the following: a question provided to the project manager, an answer provided to the project manager, and a scoring characteristic of the question.

15. The non-transitory computer-readable medium of claim 9, wherein the logic further causes the computing device to provide a project manager interface that includes fields for the project manager to define characteristics of the project.

16. The non-transitory computer-readable medium of claim 9, wherein the logic further causes the computing device to provide a scorecard to the project manager that identifies a risk level of the project with respect to the compliance area.

17. A method for compliance risk assessment comprising:
providing a plurality of questions to a project manager to determine a characteristic of a project that a project manager wishes to perform;
determining, from the characteristic, a compliance area that is associated with the project;
determining a compliance officer associated with the compliance area to assist in completing the project;
informing the compliance officer of the project;
receiving, from the compliance officer, a policy within the compliance area for completing the project;
providing, by a computing device, a project manager interface and a compliance officer interface to facilitate an electronic communication between the project manager and the compliance officer;
receiving an indication from the compliance officer that the compliance area has been completed with adherence to the policy; and
providing the indication to the project manager for display.

18. The method of claim 17 wherein the compliance risk assessment relates to information handling.

19. The method of claim 17, further comprising providing a cockpit for providing information on the project and information on a different project, wherein the project and the different project are both associated with the compliance area.

20. The method of claim 19, wherein the cockpit further comprises a graphical area for providing a graphical representation of the information on the project and the information on the different project.

21. The method of claim 17, further comprising providing an administrator interface for altering at least one of the following: a question provided to the project manager, an answer provided to the project manager, and a scoring characteristic of the question.

22. The method of claim 17, wherein the logic further causes the computing device to provide another project manager interface that includes fields for the project manager to define characteristics of the project.

23. The method of claim 17, further comprising providing a scorecard to the project manager that identifies a risk level of the project with respect to the compliance area.
